(19) United States
(12) Patent Application Publication
(10) Pub. No.: US 2017/0249389 A1
(43) Pub. Date: Aug. 31, 2017

(54) SENTIMENT RATING SYSTEM AND METHOD

(71) Applicant: FEELTER SALES TOOLS LTD, Tel-Aviv (IL)

(72) Inventors: Gilad Brovinsky, Tel-Aviv (IL); Zohar Israel, Tel-Aviv (IL); Smadar Landau, Tel-Aviv (IL)

(21) Appl. No.: 15/507,186

(22) PCT Filed: Sep. 2, 2015
(86) PCT No.: PCT/IL15/50879

§ 371 Date: Feb. 27, 2017

Related U.S. Application Data
(60) Provisional application No. 62/044,560, filed on Sep. 2, 2014.

(51) Int. Cl. G06F 17/30; G06Q 50/00; G06Q 30/02

(52) U.S. Cl. CPC G06F 17/30867; G06F 17/30899; G06F 17/30401; G06F 17/3053; G06Q 30/0282; G06Q 30/0203; G06Q 50/01

(57) ABSTRACT

A sentiment rating system adapted to processing website(s) to determine key phrases descriptive of items presented therein; mining one or more social posts (e.g. from social networks), which are indicative of the key phrases; processing the social posts to determine sentiment values expressed therein in relation to the key phrases; and based on the one or more sentiment values determine sentiment score for the key phrases. In some implementations the system includes a publisher module that embeds the sentiment scores of the key phrases within the website(s) in association with the items associated therewith. In some implementations, determination of the sentiment score includes processing the social posts to filter out social posts, which are biased, and/or from which sentiment values cannot be extracted with high confidence level, and then determining the sentiment score based on the sentiment values of social posts, which are un-biased and from which reliable sentiment values can be extracted.

### TECHNOLOGICAL FIELD

The present invention is in the field of information retrieval techniques, and more specifically relates to techniques for retrieval of sentiment information about items.

### BACKGROUND

The abundance of information available on the Internet and/or other information networks provides opportunities to make informed decision-making in relation for example to commercial items, such as products and services. This may be achieved by querying and reviewing/analyzing information data pieces entered in relation to the commercial item(s) of interest by a plurality of users/information providers of the information network.

Therefore, several techniques for exploring an information network and retrieving recommendations from the Internet have been developed in recent years. For example, US publication No. 2009/282019 discloses a system and method for recommending a product to a user in response to a query for a product with a feature. According to this technique, the recommendation is accompanied by a quotation expressing a sentiment about the feature or the product.

Also, US publication No. 2011/078157 discloses a computer-readable storage medium having stored thereon computer-executable instructions which, when executed by a computer, cause the computer to implement an opinion search engine. The instructions to implement an opinion search engine cause the computer to collect opinion data about one or more objects from the Internet, extract metadata about the opinion data from the opinion data, remove duplicate metadata from the metadata to generate a resulting metadata, categorize the resulting metadata for similar objects according to one or more taxonomies from one or more websites on the Internet and rank the similar objects based on the categorized metadata.

US publication No. 2013/018685 provides a structured sentiment expression and management system and method. The system can receive sentiment content from at least two contributing users, wherein the received content is structured according to a specific human emotion, gesture or feeling and a level of intensity of the specific human emotion, gesture or feeling. The system further displays the received content in a pre-defined and user-selected sentiment category related to the specific human emotion, gesture or feeling. In one embodiment, the system can initiate a contest requiring sentiment content in order to evaluate the winner. In one embodiment, a request from a requester for a crowd sourcing task is received, and, based upon determined social influence ratings, assign the task to a user.

US publication No. 2013/054559 discloses an online marketing research measurement that allows a user to derive and/or monitor knowledge metrics, such as awareness metrics, recommendation metrics, advocacy metrics, etc. about a target subject, such as the user's brands and/or products using existing data on the Internet. Rather than requiring responses solicited from active participants in a survey (as in traditional surveys), unsolicited opinion data residing on the Internet can be gathered and processed for deriving various types of knowledge metrics. A recommendation metric can be derived from opinion data gathered from the Internet, which reflects a measure of recommendation opinions about the target subject. Users may identify the specific brand in which they are interested. After an Internet crawler is sent out to select data, the engine cleans the results of poor quality data, codes the data according to the appropriate constructs or variables, and then scores the sentiment using the system's sentiment engine.

Acknowledgement of the above references herein is not to be inferred as meaning that these are in any way relevant to the patentability of the presently disclosed subject matter.

### GENERAL DESCRIPTION

In the following description, the phrases Reviews, Recommendations, and Social-Items and/or Social-Posts are used to designate somewhat different types of sentiment-indicative textual data pieces that are generally available on the Internet. The term review should be construed in the following description as relating to an article (e.g. such as those provided on CNET) and/or other formal publications/surveys and/or a product comparative column available on the Internet. The term recommendations should be construed as user induced “personal” opinions in relation to a product or a service, which are submitted by Internet users in dedicated places in certain commercial Internet sites (e.g. typically in e-commerce sites such as Amazon). The term social items/posts relates to user-generated data content, which is not necessarily intended to provide a formal/orderly/dedicated recommendation on a product/service, but is more directed to expressing the user's feelings/thoughts in relation to a product/service. Social posts includes for example publications/posts a user writes in social media on the internet, such as social networks and/or other locations on the web (e.g. such that it is exposed to his/her friends in the social media). To this end, it should be understood that the phrase social networks may designate various sources (e.g. social sources) of social publications, such as and not limited to social network sites and questions and answers sites.

In many cases, individual textual data items, such as Reviews, Recommendations and Social-Items, relating to a product/service, are biased towards positive or negative opinions on the product/service. This may be because the user/entity submitting the textual data item may have had an interest in the commercial success/failure of the product/service. To this end, recommendations, which are entered in many commercial/e-commerce sites, are often entered by interest-biased entities such as sellers of the product/service that is the subject of the recommendation, and/or sellers of competing product(s). Also, with the increasing popularity of social media, commercial players are also operating in this field to market their products and/or induce bad publicity to competing ones. Accordingly, social posts are sometimes also biased towards or against a product. As for Reviews and/or other types of published articles on products, these may be biased or not (depending on the publisher). Also, although this type of information is, in many cases, directed to particular product(s)/service(s) with much elaboration, it is generally less informative on the end user opinions, and also it cannot be used to provide statistics on the opinions of a plurality of end users. To this end, such reviews are often used by users/buyers at the early stages of the purchase, at which buyers make initial market searches/surveys in order to decide on the general type of products/services which fit their needs. Reviews may be less effective in convincing a potential buyer at the final purchase stages, during which a final decision is to be made with regard to which product should be bought out of few (two or more competing products which more or less fit the needs of the potential buyer). For this final decision stage, potential buyers often rely on opinions from other end-users, possibly friends, experiencing the products. Such opinions, as long as they are perceived as being un-biased, informed and reliable, are more effective, in convincing the potential buyer in the final purchase stages to decide on purchasing one of the two or more products he is considering.

A known measure of the efficacy of a commercial site (a phrase that is used herein in relation to any commercial web-site such as e-commerce site, that trades goods online—e.g. directly on the web site), is the measure of a site's conversion rate. The conversion rate may be measured for example as a ratio between the number of site visitors and the number of paying customers. Namely it measures the ability of the site to convert visitors to paying customers. The conversion rate measure of an e-commerce site performance is typically industry specific.

There are many technique aimed at improving a commercial site's efficacy and conversion rate. This includes for example a business intelligence data mining technique for monitoring users' activities on the site to identify, and possibly improve, “weak” spots on the sites, at which users/potential buyers desert; providing an on-line chat with the site's salesperson, to improve the rate of product sales; as well as introducing lists of end-user recommendations on each product (i.e. by providing users with the ability to recommend products), and a various other techniques. Yet, still, a conversion rate of a “good” commercial/e-commerce site is low, considering that many of the site's visitors enter the site with the intention to buy certain goods.

The inventors of the present invention have noted a behavioral pattern of commercial/e-commerce site users, which may be the source of the relatively low conversion rates in at least some commercial sites. Potential buyers/users of such sites typically enter the site with the intention to buy/purchase certain types of products in which they are interested. The potential buyers then survey the site looking for a few (e.g. two or more) competing products of that type that meet their needs. Often, such potential buyers also read the end-user induced recommendations on such products. Then, in a certain fraction of the cases (associated with the site's conversion rate), the user decides on one of the products and proceeds to buy it. However, in most other cases, potential buyers leave the commercial site and continue to investigate these few competing products elsewhere (e.g. on the Internet, or by querying friends who have similar products). Yet, rarely these “leaving” users come back to the same commercial site for continued purchase. This may be because they do not recall the site's details and/or because matching/better offers were found elsewhere.

The inventors of the present invention have understood that the fact that the potential buyers leave the commercial site may be sourced to the lack of un-biased and reliable information about the product on the commercial web site. Therefore there is a need in the art for a novel information retrieval (IR) technique, capable of efficient retrieval of un-biased and reliable information on items (product/services) of interest. There is also a need in the art for a novel technique for retrieving and embedding within web sites (e.g. commercial/e-commerce sites) un-biased and reliable information on items appearing in the site so as to improve the users'/customers' experience on the site, and thereby also improve the site's conversion rate.

To this end, the meaning of the terms biased information and the term reliable information should be explained.

Biased information relates to information, which has been submitted/published with intent to promote certain products/services over a competitor with no/less relevancy to the product's actual properties and advantages. To this end biased information is often injected into the Internet, in various places such as in product recommendation forms in e-commerce sites, into forums, into social media and so forth. Biased information is also in many cases concealed to appear as neutral information. In fact, in many cases humans as well as elaborated computer algorithms cannot distinguish biased from nonbiased information published on the Internet. The present invention may for example utilize history data on the information source and publication location to distinguish between biased information and non-biased information, as well as commercial words appearing in the content.

Reliable information relates to information, which can be considered to be correct with high probability. To this end, biased information may generally be considered less reliable than un-biased information. Also, statistical information gathered from a large number of un-biased sources may be considered more reliable than information gathered from a smaller number of sources. Also information collected from an informed information source (e.g. a source knowing the product/service details and/or the requirements/character of the potential buyer) may be considered as more reliable than information from an anonymous source. Therefore people often tend to rely on known publishers and/or on known people/friends rather than on anonymous publishers.

In view of the above, the present invention, in certain of its aspects, provides novel techniques for mining of substantially un-biased and reliable information on products and/or services (generally goods). Particularly, the present invention provides systems and methods for extracting sentiment information on products and/or services from the abundance of social posts (e.g. posts in the social media), which are posted in relation to such products and services. As indicated above, social posts/items are generally, on average, less biased than other types of sentiment indicative textual data pieces (opinions) about products/services that are generally available on the Internet (e.g. recommendations and/or product reviews which may be published with commercial intent. This is because the social posts/items are mostly published by private people with no particular intent to promote certain products/services. Also, since there is an abundance of social posts/items on almost every marketed product and/or service, statistical analysis of the sentiment of a plurality of such social posts may yield a reliable indication on the sentiment towards the product (e.g. the statistical variance is reduced, when a large number of samples is examined, thus providing a more reliable indication).

Thus, one broad aspect of the present invention is directed to an information retrieval technology and particularly to sentiment analysis system and methods. The sentiment analysis method of the invention includes providing a social post including a linguistic expression relating to a key phrase, and processing the social posts to determine un-biased sentiment value expressed thereby in relation to the key phrase. The processing includes:
applying bias processing to the social post to determine whether the social post is commercially biased, and filtering out the social post should the social post be determined to be biased; and
applying sentiment analysis to the social post, should it be unbiased, to determine sentiment value expressed thereby in relation to the key phrase.

In certain embodiments of the present invention the method also includes providing a plurality of social posts comprising and applying the bias processing to the plurality of social posts to identify therein a plurality of unbiased social posts. Then, the method includes applying the sentiment analysis to the plurality of unbiased social posts to determine a plurality of sentiment values which are respectively expressed thereby in relation to the key phrase. The plurality of sentiment values are processed to determine an unbiased sentiment score indicative of a sentiment towards an item described by the key phrase.

In certain embodiments of the present invention the bias processing includes applying Bag of Words (BoW) processing to the social post to recognize existence of one or more predetermined linguistic expressions therein, and utilizing the recognized linguistic expressions to determine a biasing probability indicative of the probability that the social post was published with commercial intent. The method may further include, upon identifying, that the biasing probability of a social post exceeds a predetermined biasing threshold, filtering out and removing that social post from further processing. In certain implementations, the bias processing is applied to one or more sections of the social post. The biasing probability may be determined based on the location of the biasing expressions in these sections of the social post.

In certain embodiments of the present invention the method includes providing one or more criteria indicating that a sentiment value expressed in the social post can be determined with sufficient confidence level, and applying a quality processing to the social post based on at least some of these criteria to determine whether one or more of the criteria are satisfied by one or more parts of the social post. Then, the method includes filtering out at least parts of the social post or the entire social post which does not satisfy certain combinations of the one or more criteria. To this end, in certain embodiments the one or more criteria include one or more of the following:
i. source criterion indicative of a reliability of one or more sources of the social post, wherein the method comprises determining a source of the social post at which it was published, and comparing the source with the one or more predetermined sources associated with the source criterion, to determine whether the source criterion is met;
ii. length criteria indicative of a range of textual lengths, associated with reliable sentiment evaluation, and comprising determining a textual length of the social post, and comparing the textual length with the range to determine whether the length criterion is met;
iii. Part of Speech (POS) criteria indicative of one or more required POS constituents, comprising applying POS Natural Language Processing (NLP) to the social post to determine a list of POS appearing therein and comparing the list with the one or more required POS constituents to determine whether the POS criterion is met;
iv. negative polarity sentence criteria associated with inclusion of one or more negative words in sentences of the social post;
v. relevancy criteria associated with the inclusion of phrases indicative of the key phrase in sentences of the social post;
vi. Corpus criterion associated with a degree of resemblance between the social post and a large corpus of social posts of predetermined quality, comprising estimating a quality of the social post based on the predetermined quality of the corpus and the degree of resemblance of the social post with posts in the corpus;
vii. Text format criterion which comprises estimating a quality of the social post based on one or more text format parameters of the social post;
viii. confidence level criteria associated with a confidence level of determination of sentiment values of one or more parts of the social post via application of the sentiment analysis thereto.

In certain implementations, one or more of the criteria ii. to vii. above are independently applied to individual sentences of the social post. The method would then include filtering out sentences that do not satisfy a certain criteria or combinations of criteria and/or the entire social post which includes such sentences.

To this end in certain embodiments of the present invention the method includes decomposing the social post into one or more individual sentences being constituents of the social post, and applying the sentiment analysis to determine respective sentiment values of one or more of these sentences in relation to the key phrase. In some cases, in order to reduce processing requirements, sentiment analysis is applied to a predetermined maximal number of such constituent sentences which are considered most significant. The significance of sentences may be determined for example based on at least one of the following: (i) the one or more of the criteria indicated above, and (ii) a location of the sentences in the social post (e.g. sentences appearing near the end of the social post are assigned with higher significance than sentences appearing closer to the beginning of the social post). Thereafter a sentiment value/score of the social post in relation to the key-phrase/item may be determined based on statistics (e.g. average) of the sentiment values computed for certain or all of the constituent sentences. The average may be weighted by the significance of the sentences.

In some embodiments, in order to reduce processing requirements, a time limit is imposed on the sentiment analysis of a social post and/or constituent sentence thereof. The method includes disrupting sentiment analysis processing exceeding the time limit. This enables efficient application of sentiment processing to a plurality of social posts, often with improved reliability, since in many cases, when sentiment analysis takes too long, it is often because the analyzed text is complicated, and, accordingly, the resulting analysis is less reliable.

According to yet another broad aspect of the present invention there is provided a sentiment analysis system including:
a social post retriever module adapted to obtain data indicative of a key phrase towards which sentiment data should be generated, and retrieving at least one social post relating to the key phrase;
a bias filter module adapted to filter out social posts which are biased by commercial intent; and
a sentiment analyzer processor adapted to process one or more parts of the at least one social post to determine sentiment value of the at least one social post towards the key phrase.

In some embodiments the system is configured and operable for implementing and carrying out the sentiment analysis method described above and further described in more detail below.

In some embodiments the system also includes a quality filter adapted to filter out social posts or parts thereof for which sentiment values are obtainable with low confidence levels.

In some embodiments of the system, the sentiment analyzer processor is associated with a Natural Language Processing (NLP) module and with a Bag of Words Processing (BoW) module and is adapted to processing one or more parts of the social post text by utilizing both the NLP and BoW modules to obtain an NLP based sentiment value estimation and a BoW based sentiment value estimation. The sentiment analyzer processor may be further adapted to determine the sentiment values of the one or more sentences with respect to the key phrase with high confidence level by matching polarities of the NLP based- and the BoW based-sentiment values.

In some cases the quality filter is adapted to filter out parts of the at least one social post for which NLP based- and the BoW based-sentiment values do not match.

In some embodiments the NLP module is adapted to provide estimated sentiment values in relation to a given key phrase of the textual part of the social post processed thereby, and also to provide data indicative of a confidence level by which the estimated sentiment values were determined by the NLP module. Then the quality filter is adapted to filtering out sentiment values of sentences for which the confidence level is below a predetermined confidence level threshold.

In some cases the sentiment analysis system includes a sentence decomposer module adapted to decompose the social post to one or more constituent sentences as indicated above, and to determine the sentiment of one or more of the sentences in relation to the key phrase. The sentiment analysis system may also include a sentiment value integrator module adapted to integrate the sentiment values obtained from the one or more sentences to determine a sentiment score/value of the at least one social post in relation to the key phrase.

The system may include a sentence relevancy filter module adapted to process constituent sentences to determine their relevancy to the key phrase, and to filter out constituent sentences which are less relevant key phrases. For instance, such a sentence relevancy filter module may be associated with a Bag of Words Processing (BoW) module and with a key phrase data repository storing relevant linguistic expressions related to the key phrase. The sentence relevancy filter module may be adapted to estimate a relevancy degree of each of the constituent sentences by applying BoW processing thereto to determine existence of the relevant linguistic expressions therein and to filter out the irrelevant constituent sentences for which the relevancy degree is below a certain relevancy threshold.

Alternatively or additionally, the system may include a sentence polarity filter module adapted to process the constituent sentences to identify polar sentences suspected to be negatively polarized, and to filter out such polar sentences. The sentence polarity filter module may be associated with a Bag of Words Processing (BoW) module and with a key phrase data repository storing linguistic expressions indicative of the negative sentence polarity.

In some cases the system includes a time limiter module configured and operable for limiting an operation time duration of the sentiment analyzer so as not to exceed a predetermined time duration for processing a single sentence and/or a single social post.

In some embodiments the quality filter utilizes one or more criteria, which are associated with the confidence level by which the sentiment of a social post can be determined, and determines whether the one or more criteria are satisfied, and filters out at least parts of the social post not satisfying certain combinations of the criteria. The one or more criteria may for example include the criteria described above.

In some cases the sentiment analysis itself, of a sentence, social post, and/or a text portion, may be carried out and may include a natural language processor (NLP) and a bag of words (BoW) sentiment analysis processor. The sentiment analysis module/system is adapted for processing one or more parts of the at least one social post to determine sentiment value of the at least one social post towards the key phrase, based on sentiment values obtained from the NLP based and BOW based processors.

Linguistic processing techniques may be categorized into two main processing approaches: (i) Simplified approaches for processing linguistic expressions based on word count statistics (e.g. Bag of Words (BoW) approach), but in which the order, of words and their part of speech types and their interrelations in the text are overlooked; and (ii) Complex approaches for processing linguistic expressions (e.g. Natural Language Processing (NLP) techniques), which are generally aimed at getting more particular understanding of the text meaning, by considering not only the content of words in the given text, but also the order of the words in the text, their types (to what parts of speech (POS) they belong), and the general logical structures and resulting meanings yielded from the words' order and the POS relations in the text.

A particular example of a simplified technique for processing linguistic expressions is known as the Bag-of-Words (BoW) technique. In this technique a statistical processing of the counts of different words appearing in a text is used in an attempt to classify the text to one or more categories, and, by this gain, certain insights on text content. The bag-of-words (BoW) technique is used for classification of linguistic-expressions and documents in various information retrieval and text classification systems. A linguistic expression (e.g. textual expression such as a sentence or a document) is simplified and represented as a Bag (e.g. as a mathematical multiset) of at least some of its word constituents (known as the BoW representation (BoWR). The BoWR optionally also includes data representing word frequency/multiplicity in the given text. Generally, in the simplified representation of the BoW technique, word order and grammar of the text are disregarded.

In many cases the BoW technique is used to classify texts into one or more categories. BoW techniques may be used to calculate/estimate a probability that a given text relates to one of given text categories (e.g. spam/advertize/business communication texts and/or the probability that a text relates to a certain given phrase). Some BoW techniques utilize predetermined/dynamically constructed dictionaries to categorize text/linguistic expressions into the various categories. Dictionaries may respectively contain words commonly appearing in texts of the different respective categories and the probability/frequency that they appear in such texts. A Bayesian filter may be used to process a given text based on the information in such dictionaries to determine the probability it belongs to each category.

Additionally the BoW technique may be used to determine a probability that a given text/linguistic expression is related to a given phrase/term. This may be achieved for example by utilizing the term frequency-inverse document frequency technique (TF-IDF).

With respect to the more complex NLP techniques, these are directed to more systematic and logical natural language structuring by converting chunks of text or other linguistic expressions into formal representations such as first-order logic structures which are easier for computer programs to manipulate.

The NLP includes various building block techniques, which are used in various cases to represent linguistic expressions in formal logic representations. For example, grammatical analysis techniques (also known as grammatical parsing or just parsing) are used in some cases to determine the parse tree of a given sentence. Often, the grammar for natural languages is ambiguous and typical sentences have multiple possible grammatical analyses. Indeed, in many cases, some or most of these grammatical analyses will be nonsensical to a human, and thus additional methods are used to aid a computer to distinguish between sensible and non-sensible grammatical interpretations. An additional building block of NLP techniques relates to part of speech (PoS) tagging techniques, by which parts of speech (e.g. Noun, Verb, Adjective, etc.) of words in a given text/sentence are determined. PoS tagging may be a complex, language-specific task since many words can ambiguously serve as multiple parts of speech (e.g. “book” can be a noun or verb, “set” can be a noun, verb or adjective, and “out” can be any of five different parts of speech). Additional building blocks of NLP are directed to sentence breaking techniques (i.e. sentence boundary disambiguation), by which sentence boundaries are determined in a given chunk of text; and also relationship extraction techniques, by which relationships among named entities in the text are determined (e.g. who is the wife of whom).

It should be noted that NLP processing is often more complex and time consuming than simplified statistical processing and/or categorization of texts. This may be due to the following reasons. Statistical processing, such as BoW described above, is generally based on word counting and statistical categorization based on given static or dynamic dictionaries (e.g. dictionary DBs). Such tasks are performed with relative ease by computers as they involve simple statistical models involving a relatively small number of mathematical/statistical calculations/operations. On the other hand NLP techniques are related to artificial intelligence techniques which are often implemented with complex systems/mathematical models, and are often implemented utilizing techniques such as neural networks and/or other machine learning techniques. Naturally these require significantly larger amounts of computer calculations and processing memory, and accordingly require significantly higher (e.g. by one or more orders of magnitude) computational resources (e.g. computer/processing time and memory, than simplified statistical techniques. Also in many cases, as opposed to simplified statistical models, the NLP tasks utilize language specific algorithms and language specific DB.s/training sets due to the difference in grammatical structures and PoS relationships in different languages. This may multiply the complexity of the algorithms used and/or the required memory.

NLP and its building block techniques are often used for complex language processing tasks, more elaborated than those achievable by the simpler statistical models such the BoW. NLP is often used for the purpose of Natural Language Understanding, question answering and sentiment analysis. These techniques are often based on classical NLP capabilities (sentence breaking, grammatical analysis, PoS tagging, and relationship extraction) together with semantic processing of the words in the text to derive plausible intended meaning of the text, which may be used for question answering and sentiment analysis. To this end, NLP sentiment analysis techniques are used to extract subjective information usually from a set of documents/texts, to determine “polarity” of specific objects. It is especially useful for identifying trends of public opinion in the social media. In order to understand subjective sentences, it is necessary to understand compositionality—namely to understand how words interact and modify the sentiment expressed by other words.

Compositionality, which is achievable by NLP, is much more important for accurate sentiment analysis than for text classification. Text classification into categories is achievable via more simplified statistical models, such as BoW. Therefore, since BoW models cannot achieve near human level performance in sentiment analysis, conventional NLP techniques are used for the purpose of sentiment analysis of texts.

Known NLP techniques capable of performing sentiment analysis and usable by the system and methods of the invention include for example the Stanford NLP and sentiment analysis techniques.

The inventors of the present invention have noted that even state of the art NLP techniques are often less reliable in determining sentiment from negative sentences (i.e. sentences including one or more negative polarity words, such as: no, non, either, neither, in-, im-, But and many more). This is because even most elaborated NLP techniques (e.g. based on pre-defined polarity reversing rules, and/or based on complex parse-trees machine learning schemes) often fail when trying to tackle the compositionality of negative sentences for sentiment analysis. For example, a sentence including several negative words can express either a negative or a positive sentiment (e.g. “not an im-possible task”), and also because in many cases reversed polarity phrases presented after phrases with inversed polarity are more significant to the overall sentiment polarity of the text (e.g. “a kind guy, but horribly stupid”).

To this end, the inventors of the present invention have also noted that many times the average computational resources required for processing such negative sentences are higher than those required when processing social posts, and also that the confidence level in the extraction of accurate sentiment results from such negative sentences is lower than that achievable in positive sentences (e.g. which do not include words associated with negative meaning). Accordingly, in certain embodiments of the present invention, negative polarity sentences are identified (e.g. utilizing BoW techniques and/or other statistical/word identification measures), and sentences including one or more words of a predetermined set/dictionary of negative words, are filtered out and are not further processed by the NLP systems/methods. This provides for improving the efficiency of the sentiment analysis system. This is because there is generally an abundance of social posts published by the social media in relation to each key phrase of interest, which constitute more than can be practically processed. Accordingly, since sentiment analysis of negative sentences is less reliable, and because NLP analysis of such sentences is not needed due to the abundance of other types of sentences in social posts, and also because the sentiment extraction from these sentences requires relatively high computational resources, these sentences are filtered in some embodiments of the present invention, so as to generally improve the efficiency and reliability of the sentiment analysis system of the invention.

As indicated above, potential customers are more often persuaded to purchase a product or service after receiving a favorable opinion recommending the product/service from a source which they consider to be reliable. Sources which may be considered reliable typically satisfy one or more of the following conditions: (I) they are informed/experienced with properties of the particular product/service in question; (II) they have no particular interest in marketing that particular product/service; (III) they are “alike” the potential customer who considers to purchase the product service (e.g. they may be categorized into a similar sociological group of users of this product/service (e.g. the sociological group may be defined based on the particulars of the product/service and may be based on age, gender, place of residence, language, nationality, education, marital status, and/or possibly other sociological parameters of the customer); (IV) the sources are friends of the potential customer and/or they are generally known to him/her so he/she can properly assess and value their opinions.

In view of the above, according to some aspects of the present invention there are provided systems and methods for improving the conversion rates of commercial sites by introducing, in relation to items (product/services) sold thereby, sentiment data indicative of opinions which are harvested/mined from sources which may be considered reliable by potential customers of these items. In particular, opinions in the form of sentiment indications extracted from social posts (e.g. posts/publications on various social networks) are provided. As indicated above the social posts are filtered to remove items with commercial intent and/or other underlying interests, and their sentiment extraction quality is also monitored to ensure reliable and unbiased sentiment value extraction with regard to these items. Accordingly, and also because the sentiment value is determined statistically from sentiment extracted from a plurality of social posts, the so extracted sentiment value may be considered highly reliable and unbiased.

Therefore in certain aspects of the invention this sentiment value is presented in the commercial site, in relation to the relevant item in the site. This may be used to improve the conversion ratio of the site.

In certain implementations, the sentiment values relating to items appearing in the site may be segmented in accordance with sociological/demographical parameters (age, gender, residence and/or other parameters) of the publishers of the social posts from which they are extracted. This may be used to improve the perceived reliability of these sentiment values by customers, as customers tend to perceive the opinions of people “alike” themselves as more reliable than mere general opinions. In certain implementations, the sentiment values relating to items appearing in the site may be segmented in accordance with connections between their publishers and the customer, e.g. friendship connections in social networks may be explored for this purpose and the potential customers visiting the website may choose to “see” the sentiment and/or the social posts published by their friends. This may be used to improve the conversion ratio of the site as customers tend to rely on the opinions of friends more than on the opinions of strangers. In certain implementations, not only the extracted sentiment is presented in relation to the items that are traded in the commercial site, but the customers visiting the site may also have an option to see the actual social posts/publications from which the sentiment was extracted. Also, social publications/posts may include not only textual data (from which sentiment values are extracted) but also other types of valuable information on traded items, such as pictures, videos and/or sounds. This may provide customers with valuable information regarding a product they are considering to purchase, and may help customers make informed decisions about the purchase.

Accordingly, the technology of the present invention may be implemented to present potential users/customers of a commercial site with reliable and unbiased information on various items/products services sold on the site. The information is presented in-situ in the e-commerce site and may be browsed in various depths and segmented into various social segments, to allow the user to make an informed decision about the purchase of the product and services on the site. Accordingly, the conversion rate of the site is increased.

Thus, one broad aspect of the present invention is directed to an information retrieval technology and particularly to sentiment rating systems and methods for assessing sentiment data indicative of the sentiment of the public, or certain population segments towards items appearing in a commercial site, and possibly also embedding the sentiment data in the commercial site. To this end, the present invention, according to some aspects thereof, provides a sentiment rating system including:
(i) a key phrase tracker module adapted to process at least one website to determine one or more key phrases descriptive of items presented in the website;
(ii) a social data mining module configured and operable for mining one or more social posts indicative of at least one key phrase of the one or more key phrases from at least one social network;
(iii) a sentiment analysis module adapted to process the social posts to determine one or more respective sentiment values expressed in the social posts in relation to the key phrase indicated thereby;
(iv) a key phrase sentiment processor adapted to determine at least one sentiment score for the key phrase based on one or more of the sentiment values determined from the social posts; and
(v) a publisher module adapted to embed the sentiment score within the website in association with an item described by the key phrase.

In certain embodiments the key phrase tracker module is adapted to store the key phrases in a data repository, and the social data mining module includes one or more crawler modules to carry out the following: (1) obtain the key phrase from the data repository; (2) obtain a list of one or more social networks to be mined; (3) connect to the social networks to obtain therefrom the social posts published therein and associated with the key phrase; and (4) store the social posts in a data repository associated with the key phrase.

In certain embodiments of the invention, the key phrase sentiment processor is adapted to process the sentiment values to determine a general sentiment score indicative of a sentiment expressed by the social posts in relation to the key-phrase; and the publisher module is adapted to embed the general sentiment score in the website.

Alternatively or additionally, in certain embodiments of the invention, the key phrase sentiment processor is adapted to apply segmentation to the sentiment values to segment the sentiment values into a plurality of segments based on parameters of respective social posts from which the sentiment values were derived, and determine respective segment sentiment scores indicative of a sentiment expressed by each of the segments in relation to the key-phrase. For example the one or more parameters may include one or more of the following: (i) demographic parameters associated with personal demographic properties of respective publishers of the social posts; (ii) a language of the social post, and (iii) time of publication of the social post in a social network.

In certain embodiments of the present invention the system includes a user profile retriever module adapted to obtain user profile data indicative of one or more characteristics of a user to whom a user-specific presentation of the website is to be exposed. To this end the key phrase sentiment processor may be adapted to determine at least one user specific segment of the sentiment values, in which one or more predetermined parameters of the sentiment values of user specific segment match corresponding characteristics of the user profile data, then determining at least one user specific sentiment score based on the sentiment values included in the at least one user specific segment. The publisher module may be adapted to embed the at least one user specific sentiment score in the user-specific presentation of the website. The one or more characteristics may include one or more of the following demographic characteristics of the user: gender, age, residence location, marital status, parental status (i.e. number of children), and nationality. Determining the at least one user specific segment includes matching at least one of the demographic characteristics of the user with corresponding demographic characteristics of publishers of social posts. Alternatively or additionally, the one or more characteristics include one or more social characteristics of the user (e.g. acquaintances of the user in one or more social networks). To this end, determining the at least one user specific segment may include matching at least one of the social characteristics of the user with publishers of social posts.

Additionally or alternatively, the publisher module may be adapted to process the segment sentiment scores and to present data indicative of at least one of the following: (i) sentiment scores segmented, based on demographic properties of publishers of the social posts; and (ii) evolvement of a sentiment score of the item over time.

In certain embodiments of the present invention the publisher module is adapted to publish in the website one or more social posts associated with respective key phrases. The system may include a presentation processor adapted for processing one or more social posts from which the sentiment score(s) was/were derived to determine a presentation quality rating for one or more of the social posts. The publisher module may select a predetermined number of social posts of presentation quality above a certain threshold and enable presentation thereof in the website. The presentation quality rating of a social post may be determined for example based on one or more of the following properties determined for the social post: (i) sentiment quality rating of the social post, (ii) a biasing rating of the social post; (iii) time of publication of the social posts; and (iv) multimedia content included in the social post.

In certain implementations of the present invention the system includes: (a) a background processing utility configured and operable for performing a first stage processing (typically more computationally intensive processing) to process a plurality of social posts indicative of at least one key phrase to determine sentiment data indicative of the plurality of sentiment values, respectively, expressed in the social posts in relation to the key phrase; and (b) a foreground processing utility configured and operable for applying a second stage processing to the sentiment values to determine the at least one sentiment score for the item associated with the key phrase. The first stage processing may include one or more of the following operations: obtaining one or more predetermined key phrases from a key phrase data repository; connecting to one or more social networks for receiving therefrom raw data indicative of social posts published by users thereof; processing the raw data to identify subsets of the social posts being respectively indicative of the one or more key phrases; applying a sentiment analysis to the subsets of posts to evaluate, for each post in a subset, its sentiment value in relation to a key phrase associated with the subset; and storing sentiment data in a sentiment data storage. The second stage processing may include one or more of the following operations: identifying a key-phrase indicative of the item to be rated; obtaining key-phrase related sentiment data that is stored in the sentiment data storage in association with the key phrase; applying statistical processing to the sentiment values included in the key-phrase related sentiment data to determine one or more sentiment scores for the item; and presenting the one or more sentiment scores in the website associated with the item.

According to certain embodiments of the present invention the system is adapted to be integrated with a one or more websites and is configured and operable for embedding in such websites sentiment scores that are respectively associated with items presented in the websites. The system may include one or more software components configured to be integrated within the one or more websites and adapted to establish data communication between such websites and the sentiment rating system, and to thereby carry out one or more of the following: (a) provide the system with data indicative of at least one of the following: (i) data indicative of a plurality of key-phrases descriptive of respective items presented in the websites; and (ii) data indicative of one or more properties of a profile of users to which the websites are to be presented; and (b) obtain from the sentiment rating system sentiment data indicative of sentiment scores associated with the items.

In certain embodiments of the present invention the sentiment analysis module includes a bias filter module adapted to filter out social posts which are biased by commercial intent.

In certain embodiments of the present invention the sentiment analysis module includes an NLP based sentiment analysis processor and a BOW based sentiment analysis processor both being used to determine a sentiment value of a social post in accordance with the key phrase.

According to another broad aspect of the present invention there is provided a software component adapted to be integrated within a website presenting a plurality of items, and configured and operable for establishing data communication with a sentiment rating system (e.g. such as that indicated above and described in more detail below), to carry out one or more of the following: (a) provide the sentiment rating system with data indicative of at least one of: a plurality of key-phrases descriptive of respective items presented in the website; and one or more properties of a profile of a user to which the website is presented; (b) obtain from the sentiment rating system sentiment data indicative of sentiment scores associated with the items in the website. The software component may be configured and operable for embedding presentation of at least some of the sentiment scores in association with items corresponding thereto within a presentation of the website. As indicated above the sentiment data is segmented into one or more segments based on one or more demographic and/or social properties of the user. The software component may be adapted to embed presentation of at least one of the segments in association with an item corresponding thereto within a user-specific presentation of the website. Additionally or alternatively, the software component may be adapted to embed presentation of at least one social post relating to one or more of the items.

According to yet another broad aspect of the present invention there is provided a sentiment rating method including the following operations:

(a) determining one or more key phrases descriptive of items presented in one or more websites;

(b) mining one or more social networks to harvest social posts indicative of at least one key phrase of the one or more key phrases;

(c) applying sentiment analysis to the social posts to determine one or more respective sentiment values expressed therein in relation to the key phrase;

(d) processing the one or more respective sentiment values to determine at least one sentiment score indicated by the social posts in relation to the key phrase; and

(e) embedding the at least one sentiment score to be presented in association with an item described by the key phrase in one or more of the websites which present the item.

As indicated above the method may be adapted to determine sentiment scores relating to the item and may include one or more of the following: a general sentiment score; sentiment scores segmented based on one or more parameters of respective social posts from which they are derived; at least one sentiment score segment, segmented based on at least one user specific segment (e.g. derived from posts published by publishers whose one or more characteristics match the user of the website). Another broad aspect of the present invention relates to the configuration and operation of the sentiment analysis module/system and method which is provided and used in certain implementations of the rating system indicated above. The method for applying sentiment analysis to social posts to determine one or more respective sentiment values expressed therein in relation to a given key phrase, may include processing the social posts to determine un-biased sentiment values expressed in relation to the key phrase, and using these un-biased sentiment values to determine the sentiment score. More specifically, the processing may include:
applying bias processing to the social post to determine whether the social post is commercially biased, and filtering out the social post in case it is determined to be biased; and
applying sentiment analysis to the social post, in case it is unbiased to determine a sentiment value expressed in relation to the key phrase.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A and 1B are, respectively, a block diagram and a flow chart schematically illustrating a sentiment rating system and method configured and operable according to an embodiment of the present invention for embedding sentiment scores on items within a website;

FIGS. 1C to 1E are screen captures presenting an example of a commercial website in which sentiment data/scores are embedded by the system and method of some embodiments of the invention.

FIGS. 2A and 2B are, respectively, a block diagram and a flow chart schematically illustrating a sentiment analysis system and method configured and operable according to an embodiment of the present invention.

### DETAILED DESCRIPTION OF EMBODIMENTS

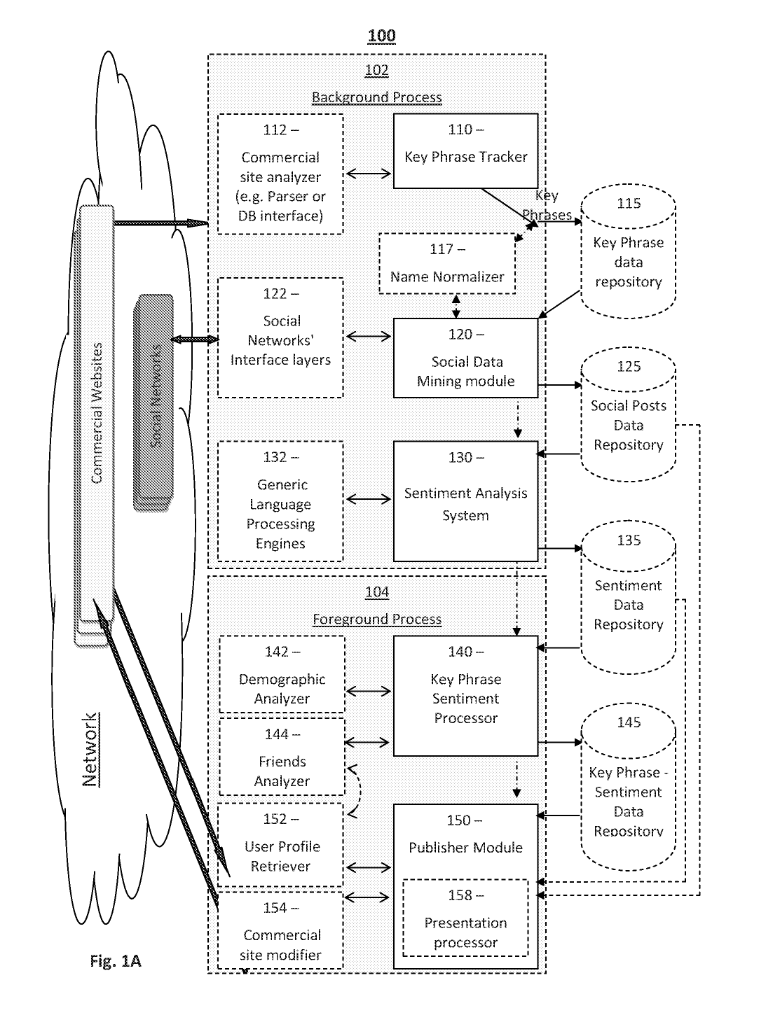

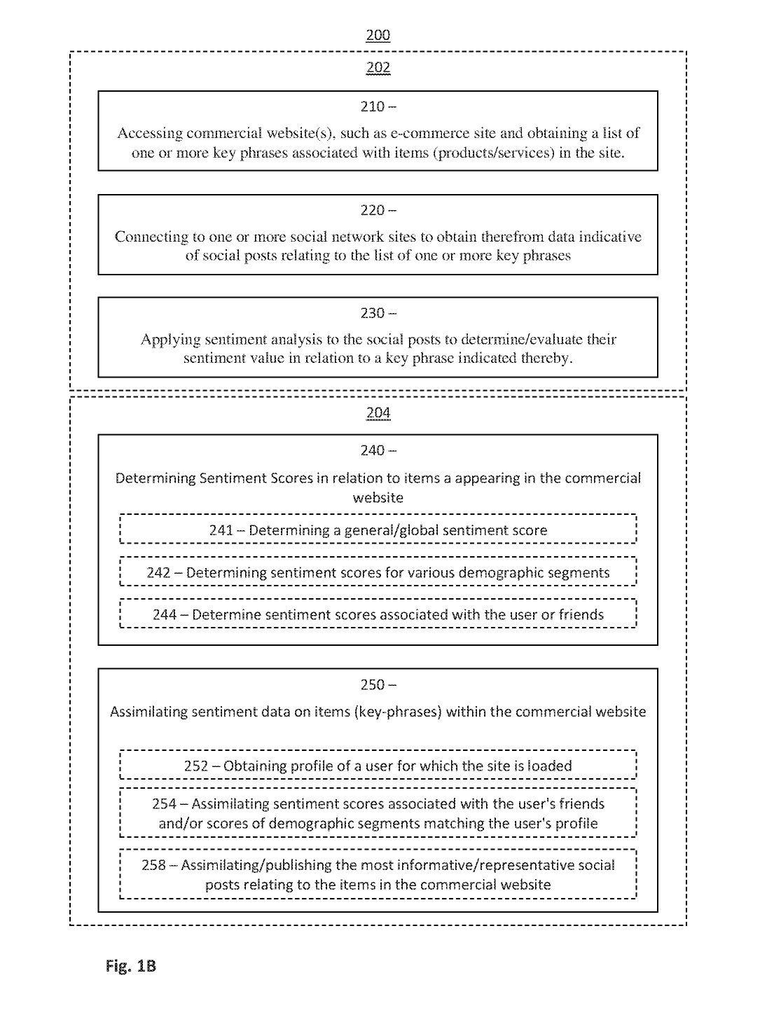

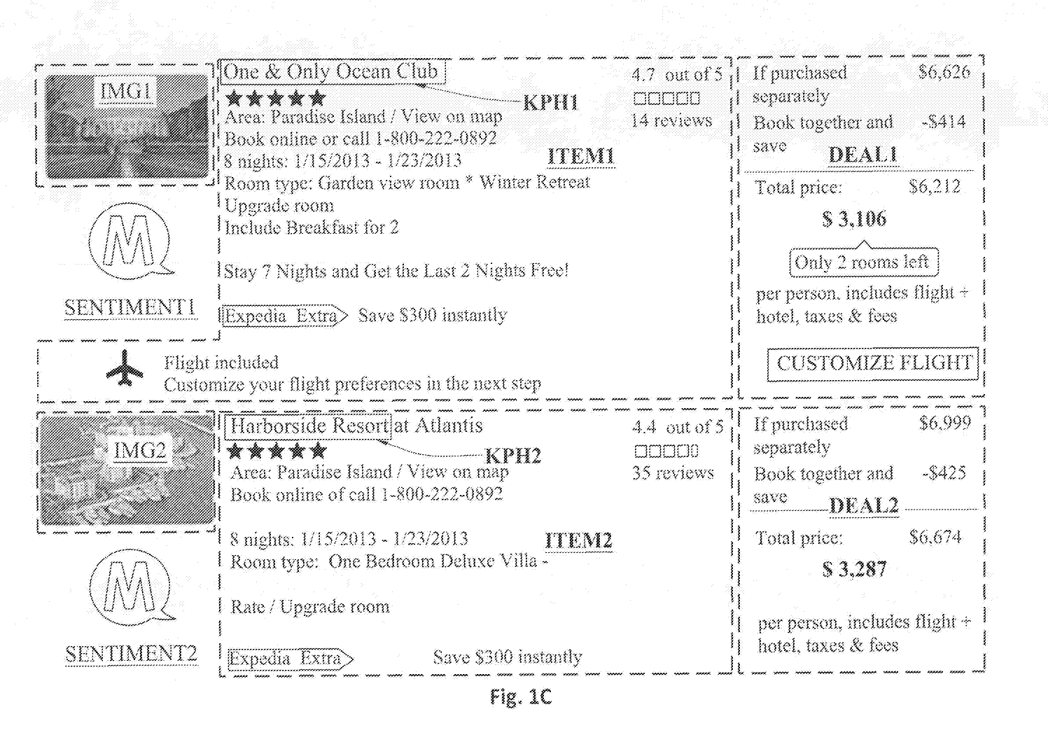

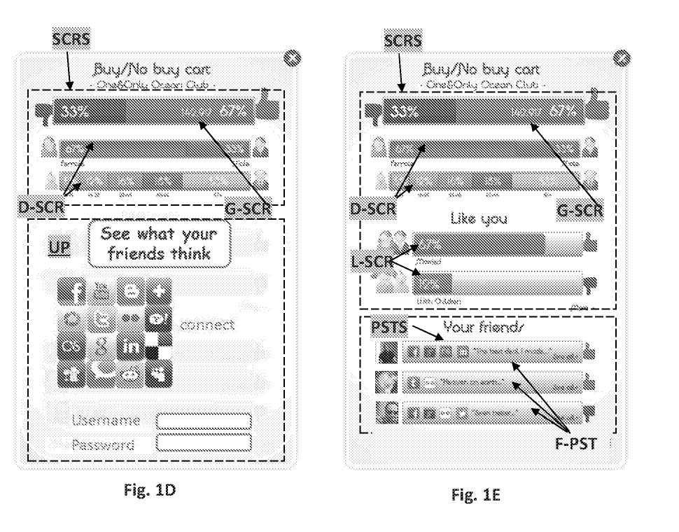

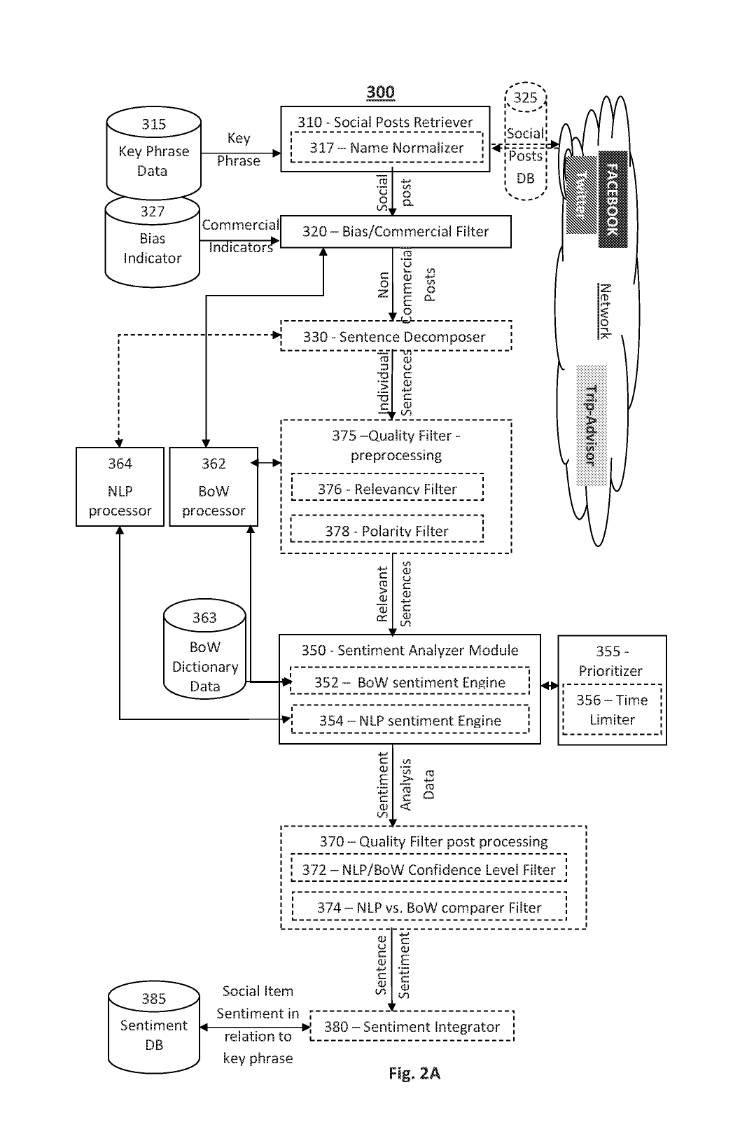

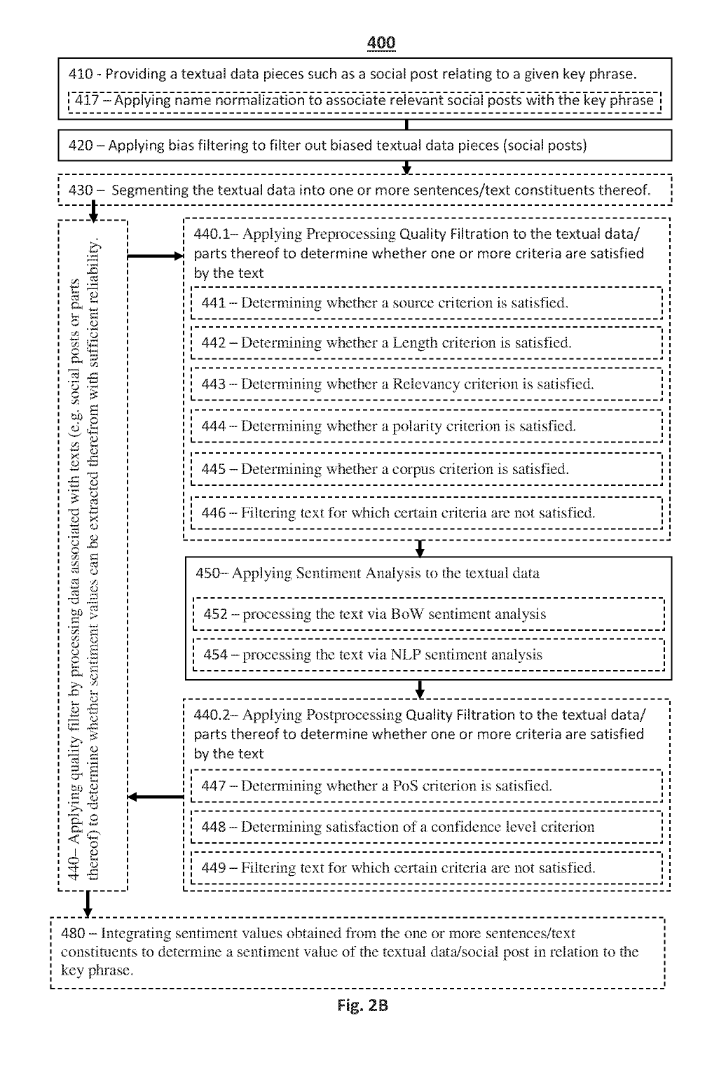

Reference is made to FIG. 1A which is a block diagram exemplifying a sentiment rating system 100 configured and operable according to some embodiments of the present invention. The system 100 includes a key phrase tracker module 110 adapted to process at least one website (e.g. a commercial website) to determine one or more key phrases indicating items presented on the website, and possibly storing the key phrases in a key phrase data repository 115 associated with the system 100. The system 100 also includes a social data mining module 120 configured and operable for mining the web for social posts indicative of one or more of the key phrases obtained by the key phrase tracker module 110 and optionally storing the mined posts and possibly also data relating thereto (e.g. multimedia data) in an optional social posts data storage 125 associated with the system. The stored data indicative of the social posts typically also includes data indicating the key-phrase(s) to which the social posts relate. The system 100 further includes a sentiment analysis system/module 130 that is configured and operable to process the social posts to determine their respective sentiments in relation to key-phrases indicated thereby. The system may optionally include, or be associated with, a sentiment data repository 135 adapted for storing data that indicate the sentiments of the social posts in relation to one or more key phrases. Preferably, in some embodiments of the present invention the sentiment analysis module 130 is capable of evaluating and filtering biased posts (e.g. posts published with explicit and/or implicit commercial intent) and/or evaluating and filtering social posts of “low quality”—namely from which the sentiment value cannot be extracted with high confidence level. A particular example of a novel sentiment analysis system 300 and method 400 according to some embodiments of the present invention, which may be effectively used in the system 100, are depicted and described in relation to FIGS. 2A and 2B. The system 100 further includes a key phrase sentiment processor 140 and a publisher module 150. The key phrase sentiment processor 140 is generally configured and operable to determine the sentiment score/rating associated with key phrases obtained by module 110 based on the sentiments which are computed from the plurality of social posts and possibly stored in the sentiment data repository 135. The key phrase sentiment processor 140 may be adapted to store the data indicative of the sentiment scores/ratings of key-phrases/items which appear on websites of interest, in a key-phrase-sentiment-data-repository 145 (which may be associated with the system) for further use. The publisher module may be adapted to embed (i.e. assimilate) key phrase sentiment data within the website.

A person of ordinary skill in the art will generally appreciate that the novel technique of the present invention as described above can be implemented with various modifications without departing from the scope of the invention as defined in the appended claims Nevertheless, in the following, certain particular embodiments implementing the present invention are described, and in some cases additional inventive features of the present invention are implemented. It should be understood that the present invention is not limited by the following description and that a person of ordinary skill in the relevant art will appreciate that various techniques and configurations may be used to implement the principles underlying the invention.

The terms module, processor, are used herein to designate any part of a computerized system, such as a computing device, which is formed by any one of the following or by their combinations: (i) hardcoded or soft-coded computer readable code executable by a computerized system, (ii) analogue circuitry, and/or (iii) digital hardware/circuitry, which when executed/operated by a computerized system, such as a server system and a client station (e.g. personal-computer/laptop/tablet), provide predetermined functionality associated with the system and method of the invention. The phrase computing device refers to any type of computer including a digital processor that is capable of executing hard/soft coded computer readable code/instructions. The phrase data repository refers to any data carrying structure or device adapted to carry and/or store data, such as a database (e.g. relational database), a data storing file (e.g. XML), and/or a data stream connection capable of carrying (receiving and/or providing) data to/from a data storage.

The phrase data indicative of a certain entity is used herein to indicate data from which one or more properties of the certain entity can be evaluated qualitatively or quantitatively.

The terms items and commercial-items are used herein interchangeably mainly to indicate items, such as goods, products and/or services, presented and/or traded in a website. The term key-phrase relates to such an item and is used herein to indicate a linguistic expression used to describe and/or to name the related item.

In this connection the phrase linguistic expression relates to any expression containing one or more words, and may designate a word, phrase, sentence and/or any other chunk of text. The phrase social posts is used herein to generally designate chunks of text published/posted/presented on the Internet, such as posts typically published in social networks by social network users.

The phrase sentiment value is used herein to indicate a value of a sentiment expressed in a social post and/or any other chunk of text in relation to a key phrase, and therefore in relation to an item the key phrase names or describes. A sentiment value towards a key phrase may be determined/estimated from a given text by applying sentiment analysis to the text. In some cases the yielded sentiment value is a polarized value being either positive, negative or neutral (e.g. 1, −1, or 0). The phrases sentiment score and sentiment-rate are used herein interchangeably to designate a total sentiment towards an item/key-phrase determined by sentiment analysis of a plurality of textual data pieces (e.g. by considering (averaging/summing) the sentiment values expressed in a plurality of social posts or other text chunks).

Referring to FIG. 1B, there is illustrated in a flow chart 200, a method for rating the sentiment of items according to an embodiment of the present invention. The method is adapted to implementing certain of aspects of the invention for seamless and automatic integration of un-biased, reliable and up-to-date sentiment data on items (products/services) published on websites, such as e-commerce sites and/or other sites.

To achieve this, in certain embodiments of the present invention the system 100 and the method 200 may be configured and operable in two modes: background mode and foreground mode, 202 and 204 respectively. System 100 may generally include a background processing utility 102 (e.g. server(s)), optionally including the modules 110, 120 and 130 operating in the background mode to carry out steps/operations 210-230 of the method 200 as described for example below.

Operation 210 includes accessing a website (e.g. commercial/e-commerce site which is to be enhanced with sentiment scores obtained by the system 100 of the invention), to obtain and possibly store in repository 115, a list of one or more key phrases (e.g. being the names of brands and/or items (products/services) traded in the site). Operation 210 may be implemented for example by module 110 described above and further described in more detail below. The websites, which are to be enhanced by sentiment information on the items presented therein, may change from time to time (e.g. may be updated to possibly include additional and/or different items). Accordingly, operation 210 may be operated in the background to monitor such websites' updates and to update the list of items/key-phrases for which sentiment data needs to be mined and processed from the web.

To this end, the key-phrase tracker module 110 may include and/or be associated with one or more commercial site analyzers 112, such as parsers and/or DB querying interfaces, capable of analyzing (e.g. by querying/parsing) the desired commercial sites to identify therein the items/key-phrases with respect to which sentiment information should be extracted. The commercial site analyzer 112 may be generic parsers/DB-interface modules, which may optionally be configurable per web-site which needs to be analyzed for parsing/analyzing the website to determine key-phrases therein. Alternatively or additionally, the commercial site analyzer 112 may include site-dedicated/custom interfaces, which may be part of the system and/or part of the website and may provide communication with the key-phrase tracker module 110 to thus provide data indicative of the list of key-phrases on the site.

Commercial site analyzer 112 may for example include web-site-parser(s)/builder(s) (e.g. HTML/XML/SSL/SCRIPT parsers and/or builders capable of performing textual analytics and processing of the of the commercial/e-commerce site (e.g. by brute-force processing), to determine relevant key-phrases therein, for example by identifying delimiters/tags (such as HTML/XML/SSL tags/elements; e.g. “ClassID” tag) indicative of relevant key-phrases in predetermined relative locations with respect thereto. Alternatively or additionally, the commercial site analyzer 112 may for example include database interfaces configurable and/or adapted for direct or indirect accessing of proper tables/data-repositories/database(s) of respective commercial/e-commerce sits associated with the system, to extract therefrom data indicative of the relevant key phrases. In any case, the commercial site analyzers 112 may include configuration utility(ies) and configuration data storage(s) (not specifically shown in the figures), which are adapted to provide an interface for receiving and storing configuration data enabling the commercial site analyzers 112 to properly access and analyze the different commercial sites (whether via parsing and/or via data access), so as to enable the system 100 to communicate with different websites. It should be understood that the above configurations of the commercial site analyzers 112 are provided only as example of two techniques, which may be used to access and analyze websites to determine key-phrases of interest therein, and that other techniques may also be implemented by the system 100 and/or by method 200 described above without departing from the scope of the present invention.

Operation 220 of method 200 includes connecting to one or more social network sites for receiving/obtaining therefrom data indicative of social posts published by users/publishers in such networks. Operation 220 further includes identifying subsets of the social posts that are related to (i.e. that are indicative of) predetermined key phrases obtained in 210, for which sentiment information should be determined. There is generally an abundance of social posts which are published every second in various social networks. Accordingly, and in order that sentiment information in each item of interest (on each key phrase) is constantly up-to-date, the operation 220 may be carried out as a background process for receiving the published social posts relating to the required key phrases.

The social data mining module 120 may include and/or be associated with one or more social-network-interface layers 122 (e.g. programmatic application interfaces (APIs)), adapted to provide access to the social data mining module 120 to posts published on their social networks. Interfaces and functionalities for accessing various social networks are typically published and regularly updated by social network companies/operators, such as Facebook, Twitter and others. Indeed, various social networks may provide different functionalities and different statistical and analytical capabilities via their published interfaces. Accordingly, social-network-interface layers 122 may be used, on the one hand, to communicate with a plurality of different social networks via their respective interfaces, while on the other hand provide the social data mining module 120 with unified/generic functionality for retrieving and possibly analyzing social posts obtained from different social networks. The social-network-interface layers may be adapted to produce, per each post, a similarly formatted data structure. The similarly formatted data structure includes for example: (i) textual publication details (e.g. caption, body/content, length, and/or additional/other parameters such as the language and time of publication); (ii) the publisher's details/parameters (e.g. personal demographic parameters of the publisher such as nationality, age, gender, place of residence, native language; and/or additional/other parameters, such as the publisher's identity and/or friends); (iii) multimedia content (e.g. images/sounds/videos); and/or possibly other additional information. The data structure of the similar format may serve for generic processing storing and storing of the posts (e.g. processing by the social data mining module 120, and storing in dedicated data repository 125 in relation to key-phrase(s) to which they relate).

For instance, the social data mining module 120 may include one or more crawlers (e.g. network/website crawlers—not specifically shown in the figure) that are adapted for crawling the web and/or certain social sites/networks. The crawlers may be configured to operate independently, for simultaneous crawling of the web, possibly by utilizing multiple server platforms. In certain embodiments the data mining module 120, and/or the crawlers thereof may utilize the social-network-interface layers 122. The one or more crawler modules are configured to carry out the following: the crawler module obtains a key phrase, for example from the data repository 115 storing key phrases of interest, and obtains data indicative of at least one social data source of interest (e.g. at least one social network out of a predetermined list of one or more social networks which are mined by the system 100). The crawler module connects to said social networks, for example via respective social-network-interface layers associated with the social network, and obtains thereby, from the social network, one or more published social posts which include data (e.g. text) relating to the key phrase. The social posts are stored in a data repository (e.g. 125) in association with the key phrase.

Additionally or alternatively, the social-network-interface layers 122 or the social data mining module 120 may be provided with functionality for identifying subsets of the social posts which are respectively indicative of the one or more key phrases of interest, and for filtering out or not receiving the social posts which do not include or are not indicative of key phrases of interest. This may be achieved by utilizing direct functionality provided by the APIs of the respective social networks (if such functionality exists). Alternatively or additionally, the social-network-interface layers 122 or the social data mining module 120 may include a filtration module (e.g. key-phrase filtration module—not specifically shown in the figure) configured for filtering social posts which are of no interest (e.g. which do not include one or more of the key phrases).

Operation 230 of method 200 includes applying a sentiment analysis processing to the social posts to determine/evaluate their sentiment value in relation to a key phrase indicated thereby. As there is generally an abundance of social posts relating to each key phrase of interest, processing of posts in each subset of the posts that relate to a particular key phrase may be systematically prioritized for sentiment processing so as to maintain the sentiment evaluation of each key phrase as being up-to-date, while optimizing the amount of processing invested per each key phrase. Sentiment analysis/processing is typically a computationally intensive task. Therefore this feature of the invention may be used to may facilitate efficient and cost effective operation of the system 100 for evaluating the sentiment of a plurality of key phrases, since otherwise far more processing time will be invested in key phrases in relation to which there is an abundance of posts, while much less time, and accordingly reduced accuracy of the sentiment evaluation might result with respect to key phrases for which less posts are published.

Also, since the sentiment analysis processing may be computationally intensive, in certain embodiments of the present invention the operation 230 is performed (e.g. by module 130) in the background processing, and the results, namely the sentiment evaluation of the social posts may be stored, in relation to both the relevant key phrase and the post from which it was extracted, in the sentiment data repository 135.

It should be noted that in certain embodiments of the present invention customary NLP/Sentiment processing engines and/or BoW engines are used. Alternatively or additionally in certain embodiments of the present invention generic/standard language processing engines 132, such as the Stanford NLP/Sentiment processing engine and/or readily-available BoW processing modules may be associated/included with the sentiment analysis module 130. However, as indicated above and will be further described in more detail below, even in cases where such readily available language processors are used in the system 100 of the invention, they typically serve only as preliminary building blocks for the sentiment analysis performed in 230 (e.g. by module 130). While these building blocks provide only preliminary results indicating the sentiment value extracted from each social post, additional operations (see for example method flow chart 400 and system 300 described below) may be implemented and carried out according to the present invention in order to facilitate computationally efficient sentiment analysis of key phrases with high reliability and reduced biasing (e.g. commercial biasing) of the sentiment results by biased posts.

For reasons indicated above, operations 210-230 may be performed in a background processing (e.g. not per demand, but performed in so-called “back office” processing), whose results are stored in suitable data repositories. In order to provide accurate and up-to-date results and to enable segmentation of the results in accordance with the results receiving entity (e.g. in accordance with the properties of the receiving person/user), operations 240 and 250 may be performed in a foreground processing (e.g. per demand/request for sentiment data on item(s), and/or in real time). Indeed, segmentation of operations 210 to 250 to the background (210-230) and foreground (240-250) operations ground provides for implementing the computationally intensive and time consuming operations in the background while carrying out the less computationally intensive operations 240-250 quickly to provide accurate and up-to-date, and optionally per user segmented results. Yet, it should be understood that division of the computational tasks to background tasks 210-230 and foreground tasks 240-250 is not essential, and that in some implementations of the system different divisions of these tasks to fore- and back-ground operations may be implemented, depending on the optimization of the system of the particular implementation. For example, in some cases, all or most of the tasks may be performed entirely in the background or in the foreground.

In operation 240, which may be performed in the foreground stage 204 by the Key Phrase Sentiment Processor module 140, sentiment ratings for one or more items appearing on the website (e.g. e-commerce web-site) are determined. Operation 240 may include the following sub operations: (i) identifying at least one key-phrase associated with at least one respective item that is to be sentiment rated in the website; (ii) obtaining, for example from the sentiment data repository 135 or directly from the sentiment analysis module 130, sentiment data/values associated with published social posts that include indication on that key-phrase; and (iii) applying statistical processing to those sentiment values to determine said one or more sentiment ratings for the key-phrase.

Typically, operation 240 includes sub operation 241 in which the key phrase sentiment processor 140 generates at least one general sentiment rating/score indicative of the general/average sentiment towards the item associated with the key phrase. The general sentiment rating may be obtained by statistical processing of the sentiment values obtained from plurality of social posts in relation to the key phrase.

For example, key phrase sentiment processor 140 may be adapted to average some or all of these sentiment values, utilizing simple averaging, and/or utilizing weighted averaging. In weighted averaging, the quality/confidence level of the sentiment values obtained from the sentiment analysis module 130 may be used for example as weighting factors. Accordingly, higher quality sentiment values obtained with a higher confidence level may have higher significance in the final sentiment score, and thus the reliability of the sentiment score may be improved. Alternatively or additionally, the times of publication of the social posts from which the sentiment values were respectively extracted may also be used as a weighting factor. In such cases sentiment values extracted from more recent posts may have higher significance in the final sentiment score, thus keeping the score up-to-date. In some cases the averaging weighting factors are determined based on a formula of both the quality/confidence levels and the time of publication to provide a high up-to-date sentiment score with high confidence. It should be understood that in some implementations other weighting factors may also be used.

In certain embodiments operation 240 includes sub operation 242 implemented by the key phrase sentiment processor 140. In such embodiments the key phrase sentiment processor 140 is adapted to extract additional sentiment ratings/scores by applying demographic segmentation to the plurality of sentiment values obtained in relation to the key phrase from the plurality of social posts. The demographic segmentations may be applied by utilizing the demographic personal data of the publishers of the posts, as may be for example obtained in operation 220 and stored in data repository 125. For example, the key phrase sentiment processor 140 may include or be associated with demographic sentiment analyzer 142 that is configured and operable to segment the sentiment values in accordance with demographical parameters, such as age ranges, gender, residence country/regions/locations, nationality, language, economical status, education and/or other demographical parameters, associated with the publishers of the social posts from which these values were extracted. The exact demographical parameters and the ranges according to which the sentiment values are segmented may be predetermined in advance and/or may be configuration parameters of the system 100. Accordingly based on the segmentation obtained from the demographic analyzer 142, the key phrase sentiment processor 140 may apply statistical processing such as simple- and/or the weighted-averaging described above, to determine demographic sentiment scores for each such demographic segment of sentiment values. Also here weighting factors based on the time of publication and/or the quality/confidence levels and/or other parameters may be used.

In certain embodiments operation 240 includes sub operation 244 implemented by the key phrase sentiment processor 140. In such embodiments the key phrase sentiment processor 140 is adapted to extract yet an additional type of sentiment ratings/scores, being user-specific sentiment ratings of an item. The phrase user-specific sentiment ratings relates to sentiment ratings towards items which are obtained by analyzing social posts from publishers, which are in some way related to the specific user to which the sentiment ratings are provided. These may be for example posts published by friends (e.g. social network connections) of the specific user, and/or posts published by posts of publishers whose demographic-properties/personal-characteristics match the personal characteristics of the specific user. Personal characteristics of the user may include demographic characteristics associated with e.g. age, gender, etc., as well as one or more social characteristics indicative of acquaintances (friends, connections) of the user in one or more social networks. The user specific segment may be determined using a match of at least one of the social characteristics of the user with publishers of social posts to be included in said at least one user specific segment.

To this end the key phrase sentiment processor 140 may include and/or be associated with a user profile retriever module 152 for receiving therefrom user profile data indicative of the specific user to which the commercial website is presented. Various techniques and exemplifying configurations of the user profile retriever module 152, by which such user profile data can be dynamically retrieved (e.g. when the website integrated with system 100 is loaded on a computerized platform (e.g. computer/Smartphone/tablet) of a particular user) are described in more detail below. The user profile may include demographic-properties/personal-characteristics data on the specific user. This data may include data identifying the user and/or it may include data indicative of friends/social-network-connections (hereinafter also referred to as friends/connections) associated with the user in one or more social networks. The latter may be first degree connections and/or more distant connections of higher degree, such as second and third degree connections depending on the particular configuration of the system 100.

Thus, in some embodiments of the present invention, the key phrase sentiment processor 140 is adapted to carry out the following operations/steps to obtain a user specific sentiment rating/score in relation to items appearing on a website loaded at the computerized client platform/station of a specific user. The key phrase sentiment processor 140 obtains user profile data indicative of personal information of the specific user to which the sentiment ratings are to be presented/provided, and obtains demographic information on publishers of social posts relating to the items. The processor 140 operates to segment the social posts into one or more segments based on a match between at least one characteristic/parameter (e.g. age/gender/marital status etc.) included in the user profile data and a corresponding characteristic in the demographic information about the publishers of the posts' characteristics. One or more user specific segments of social posts including posts published by a publisher having one or more characteristics similar to the specific user are thus determined. The one or more of these user specific segments (e.g. in a manner similar to that described above) are processed to respectively determine the one or more user-specific sentiment ratings matching the user.

Accordingly the key phrase sentiment processor 140 may be adapted to obtain user specific sentiment scores/ratings based on a “demographic” match between one or more characteristics/properties in the specific user profile and the demographic characteristics of the posts' publishers.

Alternatively or additionally, as indicated above, the user specific sentiment scores/ratings may be based on sentiments extracted from posts published by one or more of the friends/connections of the specific user. For example, the key phrase sentiment processor 140 may include and/or be associated with friends' sentiment analyzer module 144 that is directly or indirectly connected to a user profile retriever module 152 for receiving therefrom user profile data. The friends' sentiment analyzer module 144 is based on posts published by friends (e.g. acquaintances/connections) of the user exposed to the commercial website, in which they relate/express their opinions in relation to the key phrase.

In cases/embodiments where the user profile includes the user's identity (e.g. it may or may not include in this case data indicative of the user connections), the friends sentiment analyzer module 144 may be configured and operable to process social post data (e.g. which may be stored in data repository 125) and use publisher information stored in relation to social posts associated with the relevant key phrase, to determine/evaluate which of the publishers are friends/connections of the user in the one or more social networks and possibly determine their connection degree. Then, a list of social posts which relate to the key phrase and which were published by the friends/connections of the user is established.

Alternatively or additionally, in cases/embodiments where the user profile includes data indicative of the user connections, the friends sentiment analyzer module 144 may be configured and operable to process the social post data (e.g. which may be stored in data repository 125) and use the publisher information stored in relation to social posts that are associated with the relevant key phrase, to determine/evaluate lists of friends/connections of the publishers of the social posts and determine which of them matches the user. Accordingly the list of social posts which relate to the key phrase and which were published by the friends/connections of the user may also be established.

Thereafter, friends sentiment analyzer module 144 may be adapted to utilize the list of social posts relating to the key phrase, which were published by the friends/connections of the user, to process the sentiment values obtained in 230 from these posts in relation to the key phrase to estimate the sentiment score/rating (herein after friend sentiment rating) obtained by the user's connection with respect to the key-phrase and to the item to which it refers. Also statistical processing such as simple and/or weighted averaging may be applied to friends' sentiment values by the key phrase sentiment processor 140, as indicated above, in order to obtain the so-called friend sentiment score/rating.

Thus, in view of the above, in certain embodiments of the invention the key phrase sentiment processor 140 may be configured and operable to obtain sentiment scores selected from one or more of the following types: (i) general/global sentiment score indicating the general/global sentiment towards a key-phrase and underlying item by the general population of social network users/publishers that have published posts on the item; (ii) demographically segmented sentiment scores indicating sentiments towards the key-phrase and the underlying item, by different demographic segments of the social network users/publishers, which have published posts on the item; and (iii) friend sentiment scores indicating sentiment towards the key-phrase and the underlying item, obtained from posts, which have been published by friends of the specific user to which the commercial website is presented.

As indicated above, the publisher module 150 is generally adapted to assimilate sentiment scores/ratings obtained by the key phrase sentiment processor 140 in to the commercial website, in certain relevant locations at the commercial website in which items to which the sentiment respective items (key phrases) associated with the sentiment score appear. To this end the publisher module 150 may be configured and operable to carry out the operation 250 of method 200 as described in the following, and optionally implementing and carrying out optional sub operations 252 and 254.

Optionally, in certain embodiments, the publisher module 150 is also adapted to implement and carry out sub operations 256 to publish, e.g. together with the sentiments scores on each item, a number of social posts which relate to each item, for example publishing one or more social posts which were used for deriving the sentiment scores. Typically most informative/representative social posts are published or assimilated on the website in association with respective sentiment scores which were inter-alia derived therefrom.

Thus, in 250 the publisher module 150 assimilates Sentiment Scores and optionally also data indicative of the contents of related social posts (e.g. via links, or actual textual and/or multimedia data) into the commercial websites which are to be enhanced by the system 100. FIG. 1C is a self explanatory example of a screen capture (image) of such a commercial website enhanced by the technique 100 of the present invention, by introducing/publishing therein links to sentiment score data associated with respective items (in this example vacation services—hotels) which are published/marketed on the website. As shown, the image capture includes two items ITEM1 and ITEM2 being the “One&Only Ocean Club” and the “Harborside Resort at Atlantis”. The commercial website shows the item's details (which are marked in the image by the dashed boxes enclosing ITEM1 and ITEM2) including the properties of the items and user introduced reviews on the items. The figure also shows the parameters of the respective offers provided by the site with respect to the items, marked respectively in the figure by DEAL1 and DEAL2 and the enclosing dashed boxes, and images of the items marked respectively in the figure by IMG1 and IMG2 and the enclosing dashed boxes. Additionally, the figure shows links to sentiment data (sentiment scores and possibly also social items) indicative of the sentiment towards the items ITEM1 and ITEM2. The sentiment data is presented in the example by distinctive icons of the capital letter M and marked in the figure by SENTIMENT1 and SENTIMENT2 respectively associated with the two items presented in this example.

In relation to items ITEM1 and ITEM2 there are marked for example the key phrases KPH1 and KPH2 that were used to extract the sentiment. In the present example the key phrases KPH1 and KPH2 were extracted 210 (e.g. by commercial site analyzer module 112) by analyzing the site (e.g. parsing or analyzing the site's data) to identify pre-defined HTML/XML tags which were indicated in the configuration of the system 100 as indicating the captions/names of the items.

To this end, the commercial site analyzer 112 may include a site analyzer component (e.g. a website script and/or a plug-in, not expressly illustrated in the figures), which may be integrated with the website (in some embodiments it may also be a browser plug-in). The component may be for example in the form of a computer readable code that is adapted to communicate with the commercial site analyzer 112 of the system 100 to provide it with data indicative of the relevant key phrases (e.g. KPH1 and KPH2 in the commercial web site). As indicated above the component may be preconfigured (e.g. per commercial website that is to be analyzed) to identify the relevant key phrase based on predefined database scripts/structures/indicators/of the site and/or based on a predefined and preconfigured structure of the site's markup language and/or script.

FIG. 1D is an example of a frame/form/window that is opened when the user interacts with one of the links SENTIMENT1 and SENTIMENT2 (e.g. via mouse click or hovering). In this example a popup window showing the sentiment scores SCRS in relation to towards item ITEM1 is shown in a self explanatory manner. The scores SCRS are marked by a bounding dashed box on the image. In the present example the sentiment scores SCRS, include presentations of the general/global sentiment score G-SCR obtained by module 140 above (e.g. in operation 241), as well as demographic sentiment scores D-SCR segmented in accordance with demographic parameters (here in accordance with age and gender) of the publishers of social posts (e.g. in operation 242).

In the present example of FIG. 1D the website/popup shows a non-limiting example of a user profile component UP enabling the system 100 (e.g. the user profile retriever module 152) to obtain data indicative of the specific profile/parameters of the user viewing the commercial website. The user profile component UP may be a part of or associated with the user profile retriever module 152 and may operate in integration/communication with the user profile retriever module 152. In the present example the user profile component UP is a computer/browser readable code presenting a form UP within the website/popup (e.g. an data input form) integrated with the website and enabling the user to submit details (e.g. social network type/name, user-name and password), that permit the user profile retriever module 152 to access the respective social network and retrieve demographical parameters about the user and/or to retrieve data indicative of the user's friends.

Accordingly, the user profile retriever module 152 may operate to carry out operation 252 for obtaining the profile of the user for which the site is loaded. An example of how this is achieved in certain embodiments of the present invention is presented in a self explanatory manner in FIG. 1D. Here the user profile retriever module 152 includes a user profile component UP presenting a form enabling the user to actively enter data by which certain user details can be retrieved. The form includes a matrix presentation of a plurality of social network icons and input boxes for entering the user connection details (user-name and password) to the social networks. By entering the user details and clicking one of the social network icons, the user permits the profile retriever module 152 to access the respective social network to obtain certain details about him. In this case the user profile component UP communicates with the user profile retriever module 152 to provide it with data indicative of the connection details and the latter accesses the social network of the user to determine the user's demographic properties and/or friends. These may be used as indicated above to segment the sentiment scores and/or the social posts posted in relation to the items in the site based on the user's profile and to provide him with sentiment scores and with posts published by persons “like” him and/or published by his friends.

It should be understood that in some embodiments the user profile component UP (which may be considered a client side module/component) may be entirely eliminated, and retrieval of user profile/parameters in operation 252 may be performed entirely by the user profile retriever module 152 (e.g. in server side processing). It should also be noted that in some embodiments the user may not be requested to actively provide data enabling the user profile retriever module 152 to obtain user profile/parameters, and that one or more such parameters may be extracted by user profile retriever module 152 without the user's active participation. For example, the user profile retriever module 152 may be adapted to access “cookies” and/or other accessible data pieces stored on the client's computer and analyze such cookies and/or links (e.g. hyper/data links) indicated thereby to determine certain details about the user.

Sub-operation 254 includes assimilating sentiment scores and/or social posts which relate to the item ITEM1 and which are obtained from demographic segments matching the user's profile and/or from posts of the user's friends. This is illustrated in a self explanatory manner in FIG. 1E showing a popup/presentation which is similar to that of FIG. 1D in the sense that it shows the global sentiment score G-SCR and the demographic segmentation of the sentiment scores D-SCR relating to item ITEM1. Yet here this popup/presentation of sentiment is displayed after the user profile parameters have been obtained by the user profile retriever module 152. Accordingly, social scores obtained from demographic segments L-SCR matching certain profile details of user (captioned “Like You”) are presented (e.g. here segments matching the user's marital status and the number of children are illustrated). Additionally a frame PSTS showing social posts is presented in which posts F-PTS that were published by the user's friends in relation to item ITEM1 are also presented in this example (captioned “Your Friends”). It should be understood, although not specifically shown in the figure, that the sentiment score obtained from the user's friends and/or posts obtained from social network publishers which are demographically “like” the user may also be presented in some embodiments.

Optionally, regardless of the user's profile, sub operation 258 may also be carried out by the publisher module 150 to assimilate/publish a certain number of the most informative/representative social posts relating to items on the website (e.g. to ITEM1 and ITEM2). In certain embodiments the publisher module 150 includes a presentation processor 158 adapted for processing one or more social posts from which the sentiment score (e.g. the global sentiment score and/or other score) on each item has been derived to determine a presentation quality rating of at least some of these social posts. The publisher module 150 may be configured and operable to select a predetermined number of social posts for which the presentation quality is above a certain threshold and operates in 258 to present data obtained from a certain (e.g. predetermined) number of such social posts in the website in association with the item (e.g. in association with the sentiment score published with respect to the item). For example the presentation quality rating of a social post may be determined/estimated based on one or more of the following properties determined for the social post: (i) sentiment quality rating of the social post; (ii) a biasing rating of the social post; (iii) time of publication of the social posts; and/or (iv) multimedia content included in the social post. The way in which sentiment quality and biasing rating may be determined for the social posts will be explained in more detail below. In this regard, low bias rating and high sentiment quality may respectively indicate that the post was published with low/negligible commercial intent and that the sentiment value has been determined for the post with high confidence level. Accordingly, the parameters may be used as measures on how objectively reliable and relevant the post is. Also, the time of publication of the post may indicate how representative it is of the current sentiment towards the item, and therefore how relevant it is (recent posts are generally more relevant than older ones). Yet additionally, posts which include multimedia data such as images/videos and/or sounds are generally more informative and more appealing for presentation, and therefore multimedia content in a post and possibly also the number of views by network users to which the social post and/or its multimedia content have been subjected, may also serve as a measure of how relevant and informative the post is.

Therefore the presentation processor 158 may be adapted to calculate and/or use these properties with regard to various posts (e.g. possibly using a predetermined formula for measuring/estimating the relevancy of the post based on one or more of these properties of the post) and operate in 258 to present the most relevant posts in the commercial website.

In certain embodiments the presentation processor 158 of publisher module 150 is also adapted to prepare statistical presentation indicative of the evolvement of the sentiment score with respect to an item over time. To this end the key-phrase sentiment processor 140 may utilize the time of publication of different social posts to segment the posts to several time frames and calculate the social score for each time frame independently. Then the presentation processor 158 may be adapted to prepare a graphical presentation of the evolvement of the sentiment with respect to an item over time, and the publisher module 150 may present this in the web-site in association with the item so a user can assess any changes in the popularity of the respective item.

In assimilating/publishing sentiment data (social scores on items and possibly also related social posts), operation 250 may include communication with the commercial website (e.g. with the web-server at which the commercial web-site is stored and/or with an appearance of user-specific presentation of the website when it is executed/loaded on a client's station/browser) to introduce the social data in relevant locations therein. In this connection, in some embodiments the publisher module 150 includes and/or is associated with a certain one or more publishing components (not specifically shown in the figures), which may be integrated with one or more respective commercial websites and may be adapted to communicate with the publisher module 150 to obtain relevant sentiment data therefrom and introduce such data to be presented in proper locations on their respective websites. The publishing components may be implemented for example by utilizing proper server-side and/or client side scripts implementing site building/amending techniques for modifying respective commercial sites associated therewith. Indeed the components may be implemented utilizing generic scripts (such as java scripts and/or server side scripts) utilizing configuration parameters for accessing the code (e.g. markup/scripting language code) of various commercial sites to modify it to the server/client so as to present the social data. For example the publishing components may be preconfigured (e.g. per commercial website) to identify the relevant predefined structures/indicators/markup to identify the places different items are presented in the site and introduce therein data or codes for presenting the relevant social data.

For instance, in the example illustrated in FIG. 1C, icons with hyper links are introduced in each of the “forms” presenting items ITEM1 and ITEM2, wherein the hyper links are directed to refer/connect/communicate with the publisher module 150 of the system 100. The publisher module 150, may include or be associated with a web server (e.g. with web server functionality), which responds to request to receive social data on items (whose requests are sent when the icons/links are activated), to respond to such requests by the generation and loading of a suitable web page (e.g. the pop-up of FIGS. 1D and 1E) in the commercial website. Accordingly, in such implementations, the sentiment data is not necessarily being assimilated by itself in the commercial website, but links/scripts causing the provision and presentation of this data in the website are implemented.

Some embodiments of the present invention provide one or more components, (such as software components/scripts) adapted to be integrated within the web site and configured and operable for communicating with a sentiment rating system 100 to communicate at least one of the following: (i) data indicative of a plurality of key-phrases/items indicated by the website, and (ii) data indicative of one or more properties of a profile of a user to which the website is to be presented, and for obtaining from the sentiment rating system 100 sentiment data indicative of sentiment scores associated with said key-phrases/items. Optionally the sentiment data is segmented, based on one or more of the user properties and/or the friends of the user in one or more social networks. Possibly the sentiment data also includes data indicative of social posts relating to the items/key-phrases. Optionally the one or more components are also configured and operable for embedding presentation of at least some of the sentiment data within the presentation of the website in association with the key-phrases/items therein.

It should be understood that in other embodiments of the system other techniques for presenting the sentiment data in the commercial website might be used. In such techniques the data may actually be placed in the websites themselves and/or links thereto may be introduced as in the above example. Also it should be noted that other publishing components/scripts may be used and/or possibly such publishing components/scripts may be entirely obviated. The various possible techniques which may be implemented by the technique of the present invention for assimilating data, such as the sentiment data of the invention, in relation to items in various websites, will be readily appreciated by those versed in the art of website building.

Reference is now made together to FIGS. 2A and 2B respectively showing systems and methods for performing sentiment analysis according to some embodiments of the present invention. FIG. 2A is a block diagram of sentiment analysis system 300 configured and operable according to an embodiment of the present invention, and FIG. 2B is a flow chart of sentiment analysis method 400 operable according to some embodiments of the invention. Generally the system 300 may be adapted to implement method 400, or variants thereof, yet it should be understood that generally the method 400 may also be implemented by other system configurations, and that system 300 may implement somewhat different methods.

It should also be noted that according to some embodiments of the present invention, the sentiment rating system 100 and method 200 described in detail above may respectively implement/include modules and/or method operations implementing the sentiment analysis system 300 and method 400. For example, sentiment analysis system/module 130 of system 100 and the sentiment analysis operation of 230 of method 200 may include, and/or may be formed, and/or may implement, and/or may be associated with, the sentiment analysis system 300 and/or method 400 described below, so as to provide efficient and reliable sentiment analysis of social posts.

More specifically, the sentiment analysis system 300 and method 400, implement sentiment analysis techniques adapted to identify and filter one or more of the following: biased social posts (e.g. commercially biased) and/or low quality social posts, and/or posts from which the sentiment is extracted with low confidence levels. Accordingly, high quality sentiment values can be efficiently extracted with high confidence levels from non-biased social posts. This can be used in system 100 and method 200 to determine reliable and non-biased sentiment scores on commercial items traded in at least one website, and presenting these scores in the website so as to improve the website's conversion rates associated with the trade of these items.

According to some embodiments of the present invention the sentiment analysis method 400 includes operations 410, 420 and 450. Operation 410 includes providing at least one social post, which includes at least one linguistic expression relating to a predetermined key phrase of interest. Operation 420 includes applying a bias processing to the social post to determine whether it is commercially biased, and filtering out the social post in case it is determined to be biased. Then operation 450 includes applying sentiment analysis to the social post, in case it is unbiased, to determine sentiment value expressed thereby in relation to said key phrase. The method thereby provides for processing un-biased social posts to determine/estimate an un-biased sentiment value expressed thereby in relation to the key phrase.

Method 400 may be carried out to evaluate the sentiment (e.g. sentiment expressed in the internet network or in specific sites) towards a given/predetermined key phrase of interest. In operation 410, at least one social post, typically plurality of social posts, which relate to a predetermined key phrase of interest, are provided (e.g. extracted from the network or retrieved from a data-storage storing social posts previously extract from the network). In this regards, the social posts, which are retrieved in 410 are processed (during or before operation 410) to associate them with relevant ones of the key phrases of interest (e.g. key phrases stored in the Key Phrase data repository 115). Such association may be stored for example in the social posts data repository 125. Accordingly in 410 only social posts which include linguistic expression relating to the predetermined key phrase of interest are provided.

In some embodiments of the present invention, the operation 410 includes, or is associated with, optional sub-operation 417 (which may be carried out during and/or before operation 410), to apply name normalization to the key phrase and/or to certain linguistic expressions, such as item names (names of products/services), which appear in the social posts, that are to be retrieved in 410.

The name normalization may be significant in some embodiments since key phrases (e.g. extracted from eCommerce Sites) as well as social posts (social mentions of the product/service relating to the key phrase) are rarely expressed/refereed to with uniform phrasings/names in the various websites and/or social posts. For instance, in many fields, reference to certain product/service name may come under a few different names. The different names for the same product/service may vary in the order of the words therein and/or in the details/descriptive words they contain about the product/service.

For instance, an ‘Apple iPhone 5’ product may be named by all the following appearances variations in various sites and posts:

iphone 5

Apple iPhone 5

apple iPhone 5 with a black cover

However, all these product names should be treated as a single product when preparing/evaluating the sentiment towards it. Accordingly, name normalization operation 417, is carried out in certain embodiments to normalize the various names-in the social posts which refer to the same product. For instance, in the above example the name normalization may replace the references to iPhone5 in the social posts retrieved by the system by a normalized name ‘Apple iPhone 5’. Also the key-phrase relating to this product in the key phrase data repository will be also normalized to the same name.

This will advantageously result in better evaluation of the sentiment towards the product/service, since when normalizing the names, different names/references relating to the same product are consolidated and thus there are more social posts to examine per product. Also this results with avoidance of conducting duplicative evaluations for the same product when it appears under different names.

In certain embodiments the name normalization is conducted based on one or more normalization schemes. For instance for products, the name normalization scheme may be a string including the band name and product name (e.g. “<Brand> <Product> <Model>”), while trimming of other less relevant descriptors, such specification details of the product (e.g. color of the product). It should be noted that different name normalization schemes may be used for products and services, and or different optionally customized name normalization schemes may be used in different categories of products and services.

In some embodiments, the following resources are used to apply the name normalization (e.g. in accordance with the selected/predetermined name normalization scheme for a given item):
(i) Brand names lists: A lists of brands may be maintained by the system (e.g. stored in a data repository) possibly in association with their respective products. In operation 417 may utilizes the brand list to place the brand name it in key-phrases/social-posts at which there are missing, at the appropriate position (all in accordance with the name normalization scheme used).
(ii) Specifications/descriptor lists: A lists of specification descriptors which are not to be included in the normalized names, may be maintained by the system (e.g. stored in a data repository). The descriptor lists may be configured as hierarchical list. The descriptors list may be arranged in hierarchy in accordance with the category of the items/services handled by the system and the sub categories thereof. For instance, for the category of computerized systems, such as smartphones, tablets and laptops, the descriptor lists might include descriptors such as colors and memory sizes, which are less likely to have an effect on the sentiment towards such products in general. Accordingly, in method operation 417, system utilizes the descriptor list to strip/trim/remove from the key phrases and social posts, descriptors that are included in the list under the category of the item (product/service) to which the key phrase/post refers.
(iii) Regular expressions: in some embodiments regular expressions are used to identify long product names which should be shortened/truncated when normalized. The system uses the length of the key phrase as well as the count of the words, comparisons are made against trash words lists like colors, the position of each word in the key phrase is weighted, and the words for omission are selected. This may be performed based on the data of the lists above and/or other.

In some embodiments operation 417 is associated or includes another background operation/process, hereinafter referred to as name normalization scheme constructions, which is carried out to construct and/or fill the above mentioned lists of: brand-names, specifications/descriptors, and/or regular expressions; and possibly to automatically, or partially automatically, construct the name normalization scheme for each product/service or category thereof.

For instance, in some embodiments, in the normalization scheme constructions operation, may include searching for a given key phrase and/or parts thereof in the internet (e.g. via search engine) and/or in certain predetermined websites, such as Wikipedia. The results of such searches are further processed to identify the various name appearances of the product/service characterized by the key phrase, in the internet and detect/determine specifications/descriptors, which should be removed and/or brand names which should be added in order to normalize the name of the key phrase. Accordingly the brand name lists and/or the descriptor lists and/or the normalized name schemes may be constructed for different items.

For instance search results may contain a list of names of similar items (products/services) that are associated with the key phrase, but including different specifications/descriptors. The search results are filtered to leave only the list of names which are, with high confident level, associated with the key phrase. For example the search results may be filtered using the tokens from the original key phrase while enforcing a minimum threshold of existing tokens (e.g. using weights for each of the tokens in the key phrase). Accordingly, only names that are associated with the key phrase (with high confidence level) remain in the list. Then, the most common word (those appearing in the majority of names) that are used to describe the key phrase, and the most common order of those words, are identified from the remaining names in the list. These common words and their order are then identified as a normalized name/name-scheme for the item. This normalized name-scheme is used to normalize the key phrase and names in the social posts, which relate to this item. Accordingly, the results of such searches are processed, to fill/construct the brand name which should be added to the normalized names of various items; and/or to fill/construct the descriptor list with descriptors which should be removed from normalized names of various items; and/or to identify the correct order of words in a proper normalized name schemes for various items.

It should be noted that in some embodiments, processing the results returned from the web-searches include processing the URLs of those returned. For various reasons (e.g. reasons related to Search Engine Optimization (SEO)) many web sites (e.g. commercial sites) name their pages in the shortest way which can be used to uniquely identify the product/service sold/advertized on the webpage (this is often done in websites to improve traffic of users which search for that product, in all of its various forms, specifications, and configurations). Accordingly the product/service is often named in such WebPages/URLs in the way people commonly refer to its (e.g., which is not necessarily the formal name of the product). Therefore, identifying proper name normalization scheme for a given key-phrase/item is in some embodiments achieved by finding the most frequent name references used for the item in the URL part of the search results.

It is noted that in some implementations, when analyzing URLs, the source domain of the URL is also taken into consideration, as some domains may provide more accurate/reliable results than others. Accordingly operation 410 may include filtering-out/ignoring URLs/websites from certain domains, which are considered less reliable or using particular domains which use accurate product names from which reliable name schemes can be extracted.

The method 400 includes applying the bias processing 420 to the plurality of social posts to identify therein a plurality of unbiased social posts. Then, the sentiment analysis 450 is applied to the plurality of unbiased social posts for determining a plurality of sentiment values respectively expressed by the plurality of unbiased social posts. A sentiment score indicative of an unbiased sentiment towards an item described/named by the key phrase can then be determined from the sentiment values extracted from the plurality of unbiased social posts.

According to some embodiments of the present invention the sentiment analysis system 300 includes: (i) a social post retriever module 310 adapted to carry out the operation 410 of method 400 to obtain data indicative of a key phrase with respect to which sentiment data should be generated, and retrieve textual data including at least one social post relating to the key phrase; (ii) a biasing/commercial filter module 320 adapted to carry out the operation 420 of method 400 to filter out social posts which are biased (e.g. commercially biased—such as posts which were published with commercial intent to explicitly or implicitly promote/advertise goods); and (iii) a sentiment analyzer processor 350 adapted to process one or more sentences of the at least one social post to determine sentiment value of the at least one social post with respect to the key phrase.

The social post retriever module 310 is adapted to obtain data indicative of a key phrase, whose sentiment should be analyzed by the system 300 (e.g. from with the key-phrase repository 315, which may be actually the repository 115 indicated above), and to obtain data indicative of a social post to be processed by the system (e.g. from any suitable source of such posts—for example directly from social networks and/or from a data repository 325 storing such posts such as 125 indicated above).

As indicated above, in relation to operation 417 of method 400, in some embodiments the name reference of the item that is referred to by the requested key phrase is normalized according to a certain name normalization scheme. Accordingly, the social post, which may include reference to the same item, may also need to be normalized. To this end, in some embodiments of the present invention the system 300 optionally includes a name normalizer module 317, which may be configured and operable to normalize the names in the key phrases entered to the data repository 315. Alternatively or additionally, since the product/service name in the key phrase, may not be the same as in the social post referring to it, therefore in certain embodiments the item names in social posts are also normalized. For instance, a post referring to a certain similar computerized products, which are different only by the amount of memory they have (e.g. 32 GB and 64 GB respectively), may be normalized to remove this descriptor from the normalized name, since it needs not to affect the sentiment rating of the product.

The name normalization module 317 may be a computerized module (e.g. associated with a processor, a data repository and a network connection. The name normalization module 317 may include software and/or hardware modules for implementing method operation 417 described above. Alternatively or additionally, the name normalization module 317 may include/or be associated with external module/service (e.g. such as Semantics3©), which maintains and provides lists of products from hundreds of eCommerce sites.

The biasing filter module 320 is adapted to filter out social posts which are biased. The filtering of biased posts (e.g. commercially biased), is directed to the generation of a substantially neutral sentiment score/indication towards an item/key-phrase while reducing the biasing effects of commercial publications on the sentiment score generated by the system 300. In the broader sense, the system 300 configurations, which include the biasing filter module 320, are aimed to provide sentiment analytics that reliably reflect the public's sentiment towards an item/key-phrase, while reducing the effects of publications made with commercial interest to promote the specific item.

To this end, the biasing filter 320 may be configured and operable for carrying out the operation 420 of method 400 for applying of bias processing to social posts. In certain embodiments of the present invention, bias processing (BoW processing) is applied to the social post to recognize existence of one or more predetermined linguistic expressions indicative of the social post being published with commercial-intent. Each such linguistic expression may be stored in a dictionary in association with a probability that it is included in text published with commercial intent. Then 420 may also include determining, based on recognized linguistic expressions, a biasing probability indicating the probability that the social post is biased, and filtering out such biased social posts to remove them from further processing in case the biasing probability exceeds a predetermined biasing threshold. It should be noted that in some embodiments bias processing is applied independently to one or more sections of the social post, (e.g. caption section, body section, and/or to the publisher section), and biasing probability is determined in accordance with the locations at which the biasing expressions were identified. For example, existence of a biasing expression such as “Buy” may be given higher weight (i.e. higher biasing probability) should it appear in the caption part than should it appear in other sections, such as the body section. To this end the dictionary data storing biasing words may also include data indicative of their respective biasing probabilities when they appear in various locations in the social post.

Thus, in certain embodiments of the present invention the biasing filter 320 includes and/or is associated with a bias indicator data repository 327 which includes a plurality of biasing terms/phrases (e.g. buy, offer, trade, deal) which more often appear in commercial publications and/or in other types of biased publications. The biasing filter 320 may process social posts provided by the social post retriever module 310 to identify whether one or more of them appear in the examined social post, and accordingly assess whether the examined social post is a biased one which was published with specific intent (commercial intent) to promote the item.

More specifically, for example, in some embodiments of the present invention, the BoW technique is used to categorize social posts into various categories. Specifically, in some embodiments the biasing filter 320 may be based on the BoW technique and may utilize the BoW processor 362 to classify posts to a neutral (un-biased) category and one or more “biased” categories such as a commercially biased category. Alternatively or additionally, other categorizing techniques may be used for classifying posts to biased and un-biased categories.

In this connection the biasing filter 320 may include or be implemented as a probability filter, such as a Bayesian filter adapted to categorize the posts into biased and unbiased categories. The system 300 may include a bias indicator data repository 327 connectable to the Biasing filter 320. The bias indicator data repository 327 may contain predetermined and/or dynamically constructed dictionary(ies) including a plurality of linguistic expressions (words/terms/phrases) appearing in various social posts and the probabilities they appear in biased social posts and/or in un-biased social posts. The Biasing filter 320 may be adapted to assess whether each given social post is biased or not, based on the probabilities that linguistic expressions of a given social post were grabbed from different respective dictionaries stored in 327.

In some embodiments the biasing filter 320 includes/maintain a black list of words and/or regular expressions (e.g. words like ‘Cheap’), which inclusion in a social post indicates that the social post is or may be biased (e.g. posted with commercial intent). The biasing filter 320 may process the social posts retrieved by the system to identify social posts that words matching the words/regular expressions in the black list of words, and identify them as biased or potentially biased (such posts may be filtered/not-used to extract sentiment). In some embodiments the biasing filter 320 operates the BoW processor 362 in accordance with the Bayesian filter technique. The bias indicator data repository 327 may for example include at least two dictionaries, one containing words which appear with high probability in biased posts, and the other dictionary contains words that normally appear in un-biased/neutral posts. While any given word might be found in both dictionaries, the “biased” dictionary contains, for example, linguistic expressions (words/phrases) that appear with higher frequency/probability in commercially biased posts (e.g. buy, deal and others), while the regular/neutral social posts dictionary may for example contain more personal words (for example words relating to users' family, friends and workplace). Then, the probabilities of the appearance of words/terms/phrases of examined social posts may be analyzed (e.g. utilizing the Bayesian probability) to determine whether the examined social post is biased. For example, biasing filter 320 may utilize the Bayesian filtering function of the BoW processor 362 based on the dictionaries stored in the bias indicator data repository 327. To this end, the BoW processor 362 may formulate a given social post as a pile of words that has been picked out from one of the “biased” and “neutral” dictionaries, and determines, based on the Bayesian probability, from which of the dictionaries the given social post is more likely constructed. If it is more likely constructed from a biased dictionary, then the post is determined to be biased, and vice versa, if it is more likely that the post words were grabbed from the un-biased/neutral dictionary, the post is determined to be neutral.

With regards to filtering out biased social posts, the inventors of the present invention have noted that one of the most effective indicators of commercial content is the presence of links (hyper links) within the post to certain commercial sites. This is because some commercial sites, such as Amazon, encourage posting of links to their store by anyone and from anywhere (for instance Amazon affiliate program).

Thus in some embodiments, the biasing filter 320 includes or is associated with a dictionary/black-list of URLs/domain names, which are associated with such affiliate programs. The bias filter 320 processes the social posts to identify if URLs/domain names of the black-list are included in the posts, and classifies posts in which they are included as biased. The black lists of URL may be updated manually or by various method/module in the system 300. For instance the system may include a Hyper link analysis module (not shown), which monitors the URL/domain names included in all the social posts that are retrieved by the system, and enters to the black list those domain names which most frequently appear in the social posts or which most frequently appear in social posts, which are identified as commercially biased by other means (e.g. by the BoW technique indicated above).

It should be noted that in some embodiments of the present invention, the dictionaries, used to categories textual data/social posts to one or more categories, may be dynamically constructed during the processing of social posts. For example, once a social post is categorized to a certain category (e.g. biased/neutral post category) the stored dictionary of words/phrases associated with that certain category may be updated based on all of the words/phrases/terms in the post. For example the dictionary of that certain category may be updated to (i) introduce into that dictionary words that appear in the post, but were not included the dictionary of that certain category of the post; and/or (ii) to update the probabilities of words in the dictionary in accordance with the word/phrase content of the post (e.g. to update the dictionary of the post's category by increasing the probability of appearance of words that do appear in the current given post and, optionally, also reducing the probability of appearance of words that do not appear in the posts). By dynamically updating the categorizing dictionaries the system 300 may “learn” to classify posts into various categories with improved accuracy.

As indicated above, the sentiment analyzer processor 350 is adapted to process one or more sentences of the at least one social post to determine sentiment value of the at least one social post with respect to the key phrase. Sentiment analyzer processor 350 may be configured and operable for carrying out operation 450 of method 400 for applying sentiment analysis to the textual data of a social post. This may include sub operations 452 and 454 in which the text is respectively processed via BoW and NLP sentiment analysis techniques. To this end, in some embodiments of the present invention the sentiment analyzer processor 350 includes a Bag of Words (BoW) sentiment engine 352 and Natural Language Processing (NLP) sentiment engine 362, that are capable of operating independently to process social posts and/or textual portions (e.g. sentences thereof) to determine their sentiment in relation to certain key-phrases. Optionally, the sentiment analyzer processor 350 may be associated with, or may include Natural Language Processor (NLP) module 364 and a Bag of Words Processor (BoW) module 362, which may provide generic NLP and BoW functionalities. For example, the NLP module 364 may be based on the readily available Stanford NLP module and/or the BoW module may be based on conventional/known in the art BoW techniques. Alternatively or additionally, specifically designed BoW and/or NLP functionalities may be implemented and provided by modules 362 and 364.

The BoW technique may be used to determine a probability that a given text, such as a text appearing in social post, is related to a given phrase/term. This may be achieved for example by utilizing the term frequency-inverse document frequency technique (TF-IDF) technique. Accordingly, in certain embodiments of the system the BoW technique is used in a preliminary step/operation which is aimed at determining whether a given social post actually relates to the key-phrase of interest. Should it relate, further sentiment analysis may be performed, and should it not relate to the key-phrase of interest, the system may proceed to analyze another social post. As BoW processing is relatively efficient, statistical processing, requiring moderate computational resources, using this technique for preliminary filtering of non-relevant social posts, improves the efficacy of the system.

As indicated above, the BoW module 362 may be used to classify texts into one or more categories. For example, the BoW may categorize a given text into one or more categories provided there is suitable data indicative of the frequencies/probabilities of appearance of various linguistic expressions in the different text categories.

Accordingly, BoW module 362 is used in some embodiments of the present invention to provide a relatively rough estimation as to whether a given text is associated with positive, negative and/or neutral sentiment. This may be achieved by predetermined/dynamically-updated data, such as dictionaries, containing linguistic expressions associated with “positive”, “negative” and optionally also “neutral” sentiments. In certain embodiments, conventional BoW techniques are used to obtain a BoW sentiment polarity classification of social posts and/or sentences thereof. Namely, BoW-sentiment analysis may result in positive, negative and/or neutral BoW sentiment polarity. For example, in a similar way that biasing of social posts is determined, also here the BoW estimation of the sentiment may be performed by utilizing statistical information (frequency/probabilities) with respect to linguistic expressions in the “positive” and “negative” dictionaries to process the social posts/sentences according to Bayesian probability. To this end, the sentiment (e.g. “positive” and/or “negative” dictionaries) may include linguistic expressions commonly appearing (e.g. with relative high frequency) in sentences of respective “positive” “negative” and optionally “neutral” sentiment and their frequency/probabilities of appearance in sentences of such respective sentiment polarities.

It should be noted that in the technique of the invention, the dictionaries containing “positive”, “negative” expressions/words, may be constructed, maintained and/or updated by automatic/machine-learning processes, which crawl the web to harvests and analyses reviews from reviews sites. To this end, the method/system of the invention, may be configured and operable to carrying out this machine learning by harvesting particular/specifically selected review sites (which list may be stored for example in certain database storing lists of reliable sites) and may be configured and operable to process content from such sites to identify words that are frequently used to express positive sentiment (words frequently appearing in a positive reviews or positive sections of the reviews), and/or to identify words of negative sentiment (words which frequently appear in a negative reviews or negative sections of the reviews).

Alternatively or additionally, in certain embodiments the dictionaries containing “positive”, “negative” expressions/words, may also be constructed, maintained and/or updated by receiving inputs from external sources, e.g. manual input from human operators of the system. In some implementations the system provides a human interface allowing personnel to assign one of several sentiment polarity scores (e.g. five different sentiment scores: Strong-positive-word, positive-word, neutral-word, negative word, and strong-negative word). Accordingly personnel may monitor the dictionaries of positive/negative words, assign sentiment scores to the words existing therein and/or add new words indicative of positive/negative sentiments.

The automatic construction of positive/negative word dictionaries (e.g. as indicated above—by machine learning) has the advantage of being able to process huge amounts of data in a short time. Using manual human input has the advantage of providing insights to words which are not always identified by the automatic processes and/or to words of ambiguous meaning. Accordingly certain implementation of the system of the present invention include modules implementing both the automatic technique for gathering and maintaining the positive/negative word dictionaries, as well as modules/interfaces enabling receipt of human input to add/remove/update words in this dictionaries and/or their sentiment polarity meanings/scores.

Typically the system 300 also includes an NLP module 364 implementing NLP methods capable of compositionality analysis of chunks of text and generation of formal and systematic representations of text structures from which particular text meaning and/or sentiment in relation in to a given key phrase may be estimated with improved accuracy and with reduced false results, as compared to more simplified BoW processing techniques.

In various embodiments the NLP module 364 is adapted to analyze a given text/sentence, such as a social post, to provide one or more of the following functionalities (also referred to in the following as law level NLP functionalities): (i) grammatical analysis/parsing (e.g. to determine/output parse tree) of the given text/sentence; (ii) determine the parts of speech (PoS; e.g. Noun, Verb, Adjective) in the given text/sentence by utilizing PoS tagging techniques; and also (iii) relationship extraction providing sentence breaking functionalities capable of determining the relations between linguistic expressions in a given text and dividing long texts into a plurality of sentence constituents.

Typically, in some embodiments of the present invention the NLP module 364 is also adapted to perform some higher level functionalities typically including at least sentiment analysis functionality adapted to extract/determine the sentiment expressed in texts (social posts and/or sentences thereof) with respect to a certain one or more key-phrases of interest. NLP sentiment analysis is often more accurate and reliable than BoW sentiment analysis, as it typically relies on lower level NLP functionalities indicated above to formally represent the text compositions and the relation between various linguistic expressions in the analyzed text. Also NLP may utilize additional functionalities such as semantic processing to gain reliable interpretation of the analyzed texts. NLP Compositionality processing (e.g. based on low level NLP functions) and optionally also based on semantic processing of words/linguistic-expressions in the text) is used to determine how words in the text interact, and modify the sentiment expressed in the text with respect to a given phrase. Accordingly NLP provides derivation of plausible intended meaning/sentiment of the text with respect to a given phrase. Typically, NLP-sentiment polarity value is accordingly determined based on NLP processing to indicate whether the given text expresses positive, negative and/or neutral sentiment with respect to the key phrase.

It should be noted that in certain embodiments of the present invention the NLP processor 364 includes conventional NLP components (e.g. software modules) such as the Stanford NLP system, and may utilize the functions of such modules to provide higher and/or the lower level NLP functionalities. In particular, the NLP processor 364 may in some embodiments also provide NLP confidence level data indicative of a probability that an NLP sentiment value provided by the NLP is correct/accurate, and reliable. NLP module 364 may also include a suitable data repository and/or data communication providing data required for NLP processing. Use and implementation of such an NLP module 364 in the system 300 of the invention to provide some or all of the low and/or the higher level functionalities indicated above would be readily appreciated by those versed in the art, in light of the description herein.

As indicated above, certain embodiments of the present invention are aimed at extracting highly reliable sentiment scores and highly reliable sentiment values in relation to a given key phrase, by processing a plurality of social posts. Here the phrase sentiment score or rate should be understood as the sentiment value extracted from a plurality of social posts in relation to the key phrase (e.g. by averaging as indicated above) while the phrase sentiment value should be construed as relating to the sentiment (e.g. polarized value) extracted from one social post and/or from a part/sentence thereof. Reliability of the sentiment scores is important, since it should serve as an indicator of the public's sentiment towards the key-phrase and underlying item. Also, reliability of the sentiment values associated with individual social posts is important, since, in certain embodiments, the individual posts themselves are published together with data indicating their sentiment values. Therefore in case the sentiment value is incorrect, it might be recognized by users watching the publication of the individual posts with their sentiment values, which may reduce the effectiveness of the system in improving the conversion rates of websites (since, in such cases, users may perceive both the sentiment scores and values produced by the system as being unreliable).

Therefore, such embodiments of the present invention utilize both NLP and BoW techniques to independently analyze and determine sentiment values of a given social post or sentence thereof with respect to a certain key phrase(s) of interest. This yields: (i) an NLP sentiment value; and (ii) a BoW sentiment value; both of which are typically polarized values expressing positive/negative/neutral sentiment polarities towards the key phrase of interest. As sentiment extraction based on either BoW and NLP may yield erroneous results, certain embodiments of the present invention, which are directed to providing highly reliable extraction of sentiment values from text with improved generalized confidence level (better than that achievable by either one of an NLP or BoW) include both BoW sentiment engine 352 and NLP sentiment engine 354. The latter respectively applies BoW and NLP sentiment processing (e.g. via the BoW and NLP processors 362 and 364) to extract BoW and NLP sentiment values. Then, a generalized sentiment value (e.g. polarized sentiment value indicating the sentiment of a given text chunk/sentence with respect to a give key phrase) may be produced with improved confidence level from the combination of the BoW and NLP sentiment values. Certain specific implementations of this feature are described in more detail below in relation to the optional quality filter module, and particularly in relation to the post-processing part of the optional quality filter module 370.

Indeed, in general, NLP sentiment is in many cases more accurate, and is e often more accurate than BoW sentiment. This may be because BOW relies on mere statistical analysis of words in the analyzed text, while NLP in many cases includes compositionality processing, including analyzing the relations between words in the text, the words PoS, the grammar of text, and possibly also semantics. However, NLP processing is also typically more complex and time consuming than simplified statistical processing and/or categorization of texts provided by such statistical techniques as BoW.

As indicated above, certain embodiments of the present invention are aimed at extracting sentiment values from texts with high efficacy/efficiency. This is because there is generally an abundance of social posts which can be harvested from the Internet in relation to any key phrase of interest, and in order to provide reliable sentiment scores on the key phrase, it is preferable that the system 300 is capable of processing the abundance of social posts related to the key phrase, or at least a significant part thereof, with high efficacy.

To this end, the inventors of the present invention have realized that since there are a plurality of available of social posts related to any key phrase, it is not necessarily required and may also not be applicable, to apply sentiment analysis processing to all of the posts related to any given key phrase of interest. Therefore, certain embodiments of the present invention system 300 include a prioritizer module 355 configured and operable for posts for which sentiment processing is to be applied, and/or dismissing certain social posts or parts thereof. Such prioritization may be directed to assign higher priority to the processing of social posts/texts, which are expected to be processed with shorter processing time duration and/or which are expected to result in sentiment values of higher confidence levels. Alternatively or additionally, the prioritizer module 355 may be configured and operable for dismissing social-posts/sentences whose processing exceeds a given time threshold, or which are expected to result in low confidence levels (e.g. below a certain threshold).

To this end, the inventors of the present invention have noted that in many cases, texts, for which NLP processing time extends for relatively long durations (e.g. exceeding certain time thresholds—which may be determined based on the text length), often result in an NLP sentiment value provided with low confidence level (e.g. with low NLP confidence level yielded from the NLP processor). Therefore, applying sentiment processing to such texts (social posts/sentences thereof) may reduce both the efficiency/efficacy of the system 300 to the relatively long processing time required, as well as reduce the quality/confidence levels of the sentiment scores. Therefore, in certain embodiments of the present invention, the prioritizer module 355 includes/or is implemented by a time limiter module 356 that is adapted to limit the time of the NLP processing of a given text to below a certain time duration threshold. The time threshold may be a predetermined threshold and/or it may be set based for example on the lengths of the processed text. Accordingly, the time limiter 356 may be triggered by a first signal/data indicating that the NLP processing of a given text has been initialized, and the counting/monitoring of the processing time has started. In case the certain time duration threshold lapses before a second trigger which, indicates the end of the NLP processing, is received, the time limiter module 356 disrupts/stops the processing and dismisses the text (e.g. social post and/or sentence/chunk thereof) from being further processed by the system 300. Accordingly, prioritizer module 355 may provide for improving the efficacy as well as the reliability and confidence levels of the sentiment processing provided by system 300. It should be also noted that in certain embodiments the system 300 is adapted to apply other sentiment processing, such as BoW processing, to the social post/text, only after NLP processing is applied. This may further improve the system's efficiency as such other processing will not be a priority applied to texts which might be eventually dismissed during NLP processing.

As indicated above, certain embodiments of the present invention include a quality filter which is adapted to ensure that the system 300 of the present invention provides highly reliable sentiment values indicating with high confidence level the sentiment expressed in a text analyzed by the system towards a given key phrase. In certain embodiments of the present invention the quality filter is adapted to carry out operation 440 of method 400 for applying quality processing to data associated with social posts to determine whether reliable sentiment values can be extracted therefrom with high confidence. To this end, operation 440 may be aimed at determining a quality rating for the social post. In the non-limiting example of FIG. 2A, the quality filter is divided into pre-processing quality filter 375 and post-processing quality filter 370. It should be however noted that such division, although it may be associated with efficient processing, is not essential, and that some of the operations performed in the preprocessing may also be performed in the post processing, after actual sentiment analysis has been carried out.

Thus, operation 440 of method may be divided into pre-processing operation 440.1 and post-processing operation 440.2 which may be respectively performed before, and after/during execution of sentiment analysis processing 450. As sentiment analysis processing 450 is typically computationally intensive, performing preprocessing quality filtration 440.1 enables to improve both the reliability and the efficacy of the system and method of the invention, 300 and 400, as it provided for removing/filtering-out texts (e.g. social posts or parts thereof) from which sentiment values might not be extracted with sufficient reliability, before the computationally intensive operation 450 is performed. The post processing operation 440.2 may be used to further improve the reliability of the system by assessing the reliability and confidence level of the sentiment analysis based on the results of operation 450.

In certain embodiments of the present invention, operation 440 includes provision of one or more predetermined criteria indicative of the quality of a chunk of text (social post or part thereof), wherein the term quality is used herein to indicate reliability by which a sentiment value can be extracted from the chunk of text. Operation 440 includes processing the social posts or part thereof based on the predetermined criteria to assess their quality (reliability) by determining whether one or more of the criteria are satisfied by one or more parts of the chunk of text/social post and filter out at least parts of the social post which do not satisfy certain combinations of these one or more criteria.

In certain embodiments of the present invention the one or more criteria used to assess the quality of a chunk of text include one or more of the following criteria:

i. Source criterion indicative of a reliability of one or more sources of the social posts. The method 400 optionally includes operation 441 for determining a source of said social post, at which it was published, and comparing said source to said one or more predetermined sources associated with the source criterion, to determine whether said source criterion is met;

ii. Length criteria indicative of a range of textual lengths associated with reliable sentiment evaluation (e.g. here the phrase range may indicate a lower limit and/or and upper limit and/or both, of the number of words included in a text from which reliable sentiment can be extracted). The method 400 optionally includes operation 442 for determining a textual length of a text (social post/part thereof), and comparing said textual length with said range to determine whether the length criterion is met.

iii. Relevancy criteria associated with the inclusion of phrases indicative of the key phrase in sentences/other textual parts of the social post. The method 400 optionally includes operation 443 for filtering out textual parts which do not relate to the key phrase of interest.

iv. Polarity sentence criteria (e.g. also referred to herein as negative polarity). This criterion is associated with the inclusion of one or more negative words/phrases in sentences/textual parts of a social post. The method 400 optionally includes operation 444 for determining whether a text to be analyzed by the sentiment analysis engine is negatively polarized (e.g. includes negative words), and for filtering such sentences from further processing.

v. Part of Speech (POS) criteria indicative of one or more POS constituents which should be generally included in a text to enable reliable extraction of sentiment therefrom. The method 400 optionally includes operation 447 for applying Part of Speech (POS) Natural Language Processing (NLP) to the social post/text to determine a list of POS appearing therein and comparing that list with the one or more required POS constituents to determine whether the POS criterion is met. To this end the distribution of nouns, verbs and other parts of speech of the text may be used to determine its quality. More specifically, in some instances quantitative measure(s) of the distribution of the PoS in a given text is determined/calculated, (e.g. by measuring the frequency of various PoS appearing in the text), and the measure is compared with predetermined threshold(s) beyond which relations between parts of speech are indicative of low quality text.

vi. Corpus criteria indicative of a degree of resemblance between the social post and a large corpus of social posts of predetermined (a priory known) quality (e.g. corpus of high quality social posts and/or corpus of low quality social posts). In optional operation 447 the quality filter estimates the quality of the social post based on predetermined quality of the corpus and the degree of resemblance of the social post with posts in the corpus. To this end, the method 400 optionally includes providing one or more large corpuses of social posts, which were predetermined to be of high or low quality. The corpuses may be stored in a database, and in some instances of the invention each corpus is source specific, namely it includes social posts harvested from only one or more specific sources. The method 400 optionally includes carrying out operation 447 to classify the social post, based on Bayesian/BoW Classification, to determine its resemblance/difference to a corpus of high quality or low quality social posts. Then the quality of the social item may be determined/estimated in accordance with the thus determined degree of resemblance of the social item to the corpus of high/low quality social posts—for example by multiplying the degree of resemblance with the corpus's quality. In certain instances the corpuses are associated with specific social networks, and are built from social posts respectively published in the specific social networks. Accordingly the social post is matched with/classified only to specific corpuses that are associated with the particular social network from which it was harvested.

vii. Text format criteria. A further criterion that is sometimes used to assess the quality of a given text relates to the format the text. In certain implementations the method 400 includes an optional operation executed by the quality filter (not specifically shown in the figure) for estimating the quality of the social post based on one or more text format parameters, such as the text's capitalization and punctuation. The quality filter may use text capitalization to assess the “tone” of the text. For instance, text written in capital letters may be regarded as a shouting text (e.g. may be considered emphasized) and text written in lower case letters (or sentence case) may be regarded as regular/civil text. For example: “THIS IS SHOUTING” and “this is being civil”. Alternatively or additionally, in some embodiments the quality filter may use text punctuation (e.g. the existence and/or location of commas (,) dots (.) and other text punctuation) to determine/assess the text quality. For instance, ratio(s) between a count text punctuations, (e.g. in accordance with their respective types) and the length of the text is/are calculated and used to assess the text's quality. In some embodiments the system includes a trained classifier (e.g. trained neural network module and/or other type of “trainable” module, which is implemented to receive data indicative of text punctuation (e.g. the ratio(s) above) and use such data to classify the texts into two or more quality groups.

viii. Confidence level criteria associated with a confidence level of determination of sentiment values of one or more parts of said social post via application of the sentiment analysis thereto. The method 400 optionally includes operation 448 for comparing the confidence levels obtained from the sentiment analysis processing 450 to determine whether they are above a certain threshold. Alternatively or additionally, the sentiment values obtained via different sentiment analysis techniques such as NLP and BoW based techniques may be required to be of similar polarity in order to satisfy these criteria.

It should be noted that in certain embodiments of the present invention the operations 441 to 445, and optionally also operation 447 may be performed in the preprocessing quality filtration step 440.1. Operation 446 may thus include filtrating text, for which the criteria of one or more of the operations 441 to 445 and/or 447 are not satisfied. Accordingly, operations 448 and optionally also operation 447 may be performed in the post processing quality filtration step 440.2 (e.g. after or during the operation 450). Operation 449 may thus include filtering text, for which the criteria of one or more of the operations 448 and/or 447 are not satisfied).

It should be noted that criteria ii. to vii. may be applied to individual sentences of social posts, and filtering out at least the individual sentences, or the entire social post, in case certain combinations of these criteria are not met by one or more of the individual sentences.

As indicated above, in certain embodiments of the present invention, on top of calculating/of determining the sentiment score for a commercial item from a plurality of social posts (e.g. including hundreds, thousands or more posts), the technique of the present invention also provides for selecting a few records (typically not more than a few tens of social posts; e.g. up to 20) to be displayed in the website. For such presentation, it is advantageous to identify the best representable social posts indicative of the commercial item of interest. To this end the presentation quality rating indicated above in relation to operation 258 may be used. It should be noted that in certain embodiments of the present invention the presentation quality rating indicated is determined inter-alia based on the quality rating of a social post as estimated in operation 440 above by any one or more of the criteria i. to vii.

In certain embodiments of the present invention the post processing part 370 of the quality filter is adapted for performing method operation 448 and includes a NLP/BoW Confidence Level Filter 372, and/or a NLP vs. BoW comparer Filter 374.

As indicated above, commonly NLP sentiment analysis techniques/modules in many cases provide, together with the resulting data indicative of the sentiment value, also data indicating the confidence level which was obtained (i.e. referred to herein as NLP confidence level). Alternatively or additionally, also BoW techniques, or similar statistical word processing techniques, may also yield similar confidence level data (i.e. referred to herein as BoW confidence level). The NLP confidence level and/or the BoW confidence level may generally represent or be indicative of the probability that the polarities of the respective NLP/BoW sentiment values obtained by such techniques are correct. For example, analyzing a given sentence by NLP sentiment processing technique to determine its sentiment towards a key phrase may yield the following data: {SENTIMENT POLARITY: Positive; Confidence level: 51%} meaning that the sentiment is determined to be positive but with low reliability and that there may be a 49% chance that this result is not correct. Accordingly, certain embodiments of the present include the NLP/BoW Confidence Level Filter 372 which is adapted to filter out such results for which the NLP confidence level, and/or if available, also the BoW confidence level, is below a given respective confidence level threshold. In this way, only texts from which the sentiment has been extracted with high reliability are considered and further used (e.g. to determine the sentiment score towards the key phrase).

Alternatively or additionally, in certain embodiments of the present invention the quality filter 370 includes a NLP vs. BoW comparer Filter 374. This module 374 may be applicable only in the embodiments of the present invention in which both, NLP sentiment processing, and BoW sentiment processing (or other statistical sentiment processing) are applied, yielding two distinct sentiment values NLP and BoW sentiment values, which independently indicate the sentiment of the analyzed text towards the key phrase. The NLP and BoW sentiment values may not always be in agreement, for example one may indicate positive sentiment, and one may indicate negative sentiment. Therefore the NLP vs. BoW comparer Filter 374 may be adapted to compare these values and to determine whether they match. Otherwise, in case the NLP based- and said BoW based-sentiment values do not match (e.g. and possibly also considering the confidence levels obtained), the quality filter 370 is adapted to filtering out these results, and to thereby prevent use of them in further processing of the sentiment score of the key phrase.

The NLP/BoW Confidence Level Filter 372, and/or a NLP vs. BoW comparer Filter 374 are generally operable only after at least one of the NLP and BoW sentiment processing have being carried out.

In some embodiments of the present invention the quality filter also includes a preprocessing quality filter part which may implement some or all of the sub-operations of method step 440.1 to identify low quality social posts and/or textual portions thereof from which a sentiment score cannot be extracted with high confidence level, for filtering out of those social posts and/or textual portions. For example the preprocessing filter 375 is operable for filtering less relevant text portions and/or texts which are estimated to yield less reliable results.

In certain embodiments of the present invention the reprocessing filter 375 includes a sentence polarity filter 378 that is adapted to process text parts of the social posts (e.g. the whole text and/or chunks, such as constituent sentences, thereof) to identify polar text which is suspected to be negatively polarized, and to filter out the polar text. The inventors of the present invention have realized that in many cases the sentiment of texts which contain words of negative semantics (such as: not, but, and others), are incorrectly interpreted by sentiment analysis techniques such as NLP and BoW. Such texts/sentences are referred to herein as negatively polarized sentences—although it should be understood that they can also be actually positively polarized. To this end, in certain embodiments of the present invention, specifically where there exists an abundance of text that can be analyzed with respect to the key-phrase of interest, it may be preferable to dismiss such negatively polarized sentences from further sentiment analysis and thereby improve both the quality the sentiment scores obtained by the system.

Therefore in such embodiments system 300 includes the sentence polarity filter 378 which is adapted to identify negatively polarized texts/sentences and filter them. For example, the sentence polarity filter 378 may be associated with a negative words data repository (not specifically shown) storing linguistic expressions indicative of negative sentence polarity (e.g. such as not, but etc). The sentence polarity filter 378 may include a text parser (not specifically shown) and/or it may be associated with the BoW processor module 362 and may be adapted to operate the text parser and/or the BoW processor module 362 to identify the existence of one or more words from the negative words data repository in the texts. In case existence of such words is determined, the text is dismissed from being further processed by the system.

It should be noted that each social post and/or other text being analyzed by the system 300 may be composed of one or more parts (e.g. caption, body, and/or publisher) and/or from one or more sentences constituting it. Indeed, often, certain parts of the texts do not necessarily include any indication relating to the key-phrase of interest, and therefore it is preferable to skip/dismiss analysis of such parts in order to improve the system's efficacy. Additionally, in some cases there are two or more sentences/parts in the text which relate to the key phrase, and which may be independently indicative of similar or different sentiment polarities in relation to the key-phrase.

Therefore, in certain embodiments of the present invention, system 300 includes a decomposer module 330, hereinafter referred to as sentence decomposer, adapted to carry out optional operation 430 of method 400 to segment/decompose the text (e.g. from a social post) into one or more sentences/parts constituent thereof. The preprocessing/sentence filter 375, the sentiment analyzer module 350, and the quality filter 370, may be configured to operate in each of the constituent parts/sentences of the texts independently to either determine their sentiment values/scores in relation to the key phrase, or to dismiss them from being further processed. In such embodiments the system 300 may also include a sentiment value integrator module 380 that is adapted to integrate the sentiment values obtained from said one or more sentences to determine the global sentiment score/value of the entire social-post/text in relation to the key phrase.

As indicated above, different sentences of the same text may yield similar sentiment values and/or opposite values. In certain embodiments the sentiment value integrator module 380 may be configured and operable to determine a sentiment value of a text/social post by carrying out operation 480 of method 400. Namely, integration of sentiment values obtained from the one or more sentences/text constituents of the social post are used to determine a global sentiment value thereof in relation to the key phrase. For example the global sentiment value of a social post may be determined by averaging the values obtained from the plurality of sentences of the analyzed text. The averaging may be a simple averaging or may be a weighted averaging. Optionally the confidence levels/reliability scores associated with the determination of the sentiment values of different sentences are used as weights in the averaging. Alternatively or additionally, significance scores indicative of the significance of the sentences in the social post are used to determine the averaging weights.

For example, in certain embodiments the sentiment analysis is applied to a predetermined maximal number of sentences of the social post/analyzed text. A significance score may be respectively determined in relation to sentences of the social post/text. For example, such a significance score may be determined for each given sentence of the text based on at least one of the following: (i) the compliance of the sentence with the one or more quality criteria measures indicated above in relation to operation 440, and/or (ii) a location of the given sentences in the text/social post. In certain embodiments, a predetermined number of most significant sentences (for which a significance score was calculated in the manner described above) are processed by the sentiment analyzer to determine their sentiment value and are further processed by the integrator module 380 to determine the global sentiment value of the social post.

In certain embodiments of the present invention, in case different parts/sentences of a given text/social-post have yielded sentiment values of opposite polarity, the integrator module 380 may dismiss the entire social post/text from being considered, and the global sentiment of the post may be set to neutral and/or to un-determined. This is because in such cases where the text is ambiguous and expresses both good and bad sentiment towards a given item/phrase, the sentiment value results may be incorrect.

In this regard, it should be noted that in cases where the text social-post is decomposed by module 330, and although the modules 375 and 370 may operate on each of the constituent parts/sentences of the text independently, in various embodiments of the present invention the filtering effects of these modules may be applied to only to the specific sentences/text parts analyzed thereby, or to the entire text/social post from which the analyzed constituent sentence was grabbed. This depends on the particular configuration of system 300. For instance, in case the polarity filter 378 and/or the quality filter 370 identify negatively polarized sentence and/or the sentence's sentiment is obtained with low confidence level, it may be the case that only the specific constituent sentence is dismissed from consideration in the global/final sentiment value of the text/social post, or that the entire text/social post is dismissed and its global sentiment value is ignored (e.g. not calculated and/or not stored in the data repository 385).

It should also be noted that in embodiments wherein text is decomposed into its constituent ports/sentences, the preprocessing filter 375 may include relevancy filter module 376 (hereinafter ‘sentence relevancy filter’) configured and operable to process the constituent sentences/parts of the text/social post to determine their relevancy to the key phrase of interest, and to filter out/dismiss from further processing those sentences which are not relevant (e.g. which do not relate) to the key phrase (hereinafter ‘irrelevant constituent sentences/parts’). Accordingly, only the relevant sentences are retained and further processed by the sentiment analyzer 350 thus improving the efficacy of the system.

To this end, the relevancy filter module 376 may be associated with the BoW module 362, and/or with another text parser (not specifically shown in the figure) and may be adapted to process the constituent parts/sentences of the text/social item to determine whether the key phrase appears therein, and accordingly whether they are relevant to the key phrase. For example, the relevancy filter 376 module may be adapted to estimate a relevancy degree of each of the constituent sentences by applying BoW processing thereto, to determine existence of relevant linguistic expressions therein associated with the key phrase therein and to filter out irrelevant constituent sentences for which the relevancy degree is low or below a certain relevancy threshold. This may be achieved for example by utilizing the term frequency-inverse document frequency technique (TF-IDF) to identify how related a given text is, to the key phrase.

1. A sentiment rating system comprising:
a key phrase tracker module adapted to process at least one website to determine one or more key phrases descriptive of items presented in said website;
a social data mining module configured and operable for mining one or more social posts indicative of at least one key phrase of said one or more key phrases from at least one social network;
a sentiment analysis module adapted to process said social posts to determine one or more respective sentiment values expressed in said social posts in relation to the key phrase indicated thereby;
a key phrase sentiment processor adapted to determine at least one sentiment score for said key phrase based on one or more of the sentiment values determined from said social posts; and
a publisher module adapted to embed said sentiment score within said website in association with an item described by said key phrase.

2. (canceled)

3. (canceled)

4. The system of claim 1, wherein the key phrase sentiment processor is adapted to apply segmentation to said sentiment values to segment said sentiment values into a plurality of segments based on parameters of respective social posts from which the sentiment values were derived, and determine respective segment sentiment scores indicative of a sentiment expressed by each of said segments in relation to the key-phrase.

5. The system of claim 4, wherein said one or more parameters include one or more of the following: (i) demographic parameters associated with a personal demographic properties of respective publishers of the social posts; (ii) a language of the social post, and (iii) time of publication of the social post in a social network.

6. The system of claim 5, wherein said demographic parameters include one or more of the following: gender, age, residence location, marital status, number of children, and nationality.

7. The system of claim 1, comprising a user profile retriever module adapted to obtain user profile data indicative of one or more characteristics of a user to whom a user-specific presentation of said website is to be exposed; the key phrase sentiment processor being adapted to determine at least one user specific segment of the sentiment values, in which one or more predetermined parameters of the sentiment values of user specific segment match corresponding characteristics of said user profile data, and determining at least one user specific sentiment score based on the sentiment values included in said at least one user specific segment; said publisher module being adapted to embed said at least one user specific sentiment score in said user-specific presentation of the website.

8. The system of claim 7, wherein said one or more characteristics include data indicative of one or more of the following demographic characteristics of the user: gender, age, a residence location, marital status, number of children the, nationality; and wherein the determining of said at least one user specific segment includes matching at least one of the demographic characteristics of the user with corresponding demographic characteristics of publishers of social posts to be included in said at least one user specific segment.

9. The system of claim 7, wherein said one or more characteristics include data indicative of one or more social characteristics of the user indicative of acquaintances of said user in one or more social networks; and wherein determining said at least one user specific segment includes matching at least one of the social characteristics of the user with publishers of social posts to be included in said at least one user specific segment.

10. The system of claim 7 wherein said publisher module is adapted to process said segment sentiment scores to present data indicative of at least one of the following: (i) sentiment scores segmented based on demographic properties of publishers of the social posts; and (ii) evolvement of a sentiment score of said item over time.

11. The system of claim 1, wherein said publisher module is adapted to publish in said website one or more social posts in association with respective key phrases indicated thereby.

12. (canceled)

13. (canceled)

14. The system of claim 1 comprising:
(a) a background processing utility configured and operable for performing a first stage processing to process a plurality of social posts indicative of at least one key phrase to determine sentiment data indicative of the plurality of sentiment values, respectively, expressed in said social posts in relation to said key phrase; and
(b) a foreground processing utility configured and operable for applying a second stage processing to said sentiment values to determine said at least one sentiment score for said item associated with said key phrase.

15. (canceled)

16. (canceled)

17. (canceled)

18. The system of claim 1, adapted to be integrated with one or more websites and configured and operable for embedding in said websites sentiment scores respectively associated with items presented in the websites.

19. The system of claim 18, comprising one or more software components configured to be integrated within said one or more websites and adapted to establish data communication between a website integrated with one or more of said components and the sentiment rating system to carry out one or more of the following:
(a) provide the system with data indicative of at least one of the following: (i) data indicative of a plurality of key-phrases descriptive of respective items presented in said websites; and (ii) data indicative of one or more properties of a profile of users to which the websites are to be presented;
(b) obtaining from said sentiment rating system sentiment data indicative of sentiment scores associated with said items.

20. The system of claim 1, wherein said sentiment analysis module comprises a bias filter module adapted to filter out social posts which are biased by commercial intent.

21. (canceled)

22. A component of a sentiment rating system, which is adapted to be integrated within a website presenting a plurality of items, and which is configured and operable for establishing data communication with a sentiment rating system to carry out one or more of the following:
(a) provide said sentiment rating system with data indicative of at least one of the following: (i) data indicative of a plurality of key-phrases descriptive of respective items presented in said website; and (ii) data indicative of one or more properties of a profile of a user to which the website is to be presented;
(b) obtaining from said sentiment rating system sentiment data indicative of sentiment scores associated with said items.

23. (canceled)

24. (canceled)

25. (canceled)

26. A sentiment rating method comprising:
(a) determining one or more key phrases descriptive of items presented in one or more websites;
(b) mining one or more social networks to harvest social posts indicative of at least one key phrase of said one or more key phrases;
(c) applying sentiment analysis to said social posts to determine one or more respective sentiment values expressed therein in relation to said key phrase;
(d) processing said one or more respective sentiment values to determine at least one sentiment score indicated by said social posts in relation to said key phrase; and
(e) embedding said at least one sentiment score to be presented in association with an item described by said key phrase in one or more of the websites which present said item.

27. (canceled)

28. The method of claim 26, wherein said processing comprises segmenting said sentiment values into a plurality of segments based on one or more parameters of respective social posts from which the sentiment values were derived, and determining respective segment sentiment scores indicative of a sentiment expressed by each of said segments in relation to the key-phrase.

29. (canceled)

30. (canceled)

31. The method of claim 26, comprising retrieving user profile data indicative of one or more characteristics of a user to which user-specific presentation of the at least one website is to be exposed; wherein
said processing comprises utilizing said user profile data to determine at least one user specific segment of said sentiment values, wherein said user specific segment is characterized in that one or more predetermined parameters of the sentiment values included in said user specific segment match corresponding characteristics of said user provided in said user profile data;
said processing comprises determining at least one user specific sentiment score based on the sentiment values included in said at least one user specific segment; and
said embedding includes embedding said at least one user specific sentiment score to be presented in association with an item described by said key phrase in said user specific presentation of the at least one website.

32. (canceled)

33. (canceled)

34. The method of claim 26, comprising applying presentation quality processing to one or more of the social posts from which said sentiment score was derived and determining presentation quality ratings for one or more of said social posts; and wherein said embedding includes selecting a predetermined number of social posts of presentation quality above a certain threshold and assimilating said predetermined number of social posts in said website in association with said sentiment score; and wherein the presentation quality rating of a social post is determined based on one or more of the following properties determined for the social post: (i) sentiment quality rating of said social post, (ii) a biasing rating of the social post; (iii) time of publication of the social posts; (iv) multimedia content included in the social post.

35. (canceled)

36. The method of claim 26, comprising a first processing stage configured for performing operations (a) to (c) as a background process; and a second processing stage configured for performing operations (d) and (e) as a foreground process carried out for presenting one or more updated sentiment scores in said website.

37. The method of claim 26, wherein said applying of the sentiment analysis to said social posts, to determine one or more respective sentiment values expressed therein in relation to said key phrase, comprises processing said social posts to determine un-biased sentiment values expressed thereby in relation to said key phrase, said processing comprising:
applying a bias processing to said social post to determine whether said social post is commercially biased, and filtering out said social post in case said social post is determined to be biased; and
applying sentiment analysis to said social post, in case it is unbiased to determine sentiment value expressed thereby in relation to said key phrase.

38-68. (canceled)
